(19) United States
(12) Patent Application Publication
(10) Pub. No.: US 2026/0007159 A1
(43) Pub. Date: Jan. 8, 2026

(54) Method and Apparatus for Pitting Fruit

(71) Applicant: Ashlock Company, A Division of Vistan Corporation, San Leandro, CA (US)

(72) Inventors: Theodore Russell Hubbard, Walnut Creek, CA (US); Min Lat Yin, Daly City, CA (US); Patrick M. Campbell, North Fort Myers, FL (US); Akhilesh Pandey, Walnut Creek, CA (US)

(21) Appl. No.: 19/256,768

(22) Filed: Jul. 1, 2025

Related U.S. Application Data
(60) Provisional application No. 63/667,694, filed on Jul. 3, 2024.

(51) Int. Cl. A23N 4/08; A23L 5/20; A23L 19/00; A23N 3/04

(52) U.S. Cl. CPC A23N 4/08; A23L 5/20; A23L 19/03; A23N 3/04

(57) ABSTRACT

A pitting head assembly of an apparatus that grabs onto a fruit (e.g., Medjool or other date) with a gripper assembly in the pitting head assembly and further grabs onto an end portion of the pit near the calyx of the fruit with a plucker assembly in the pitting head assembly. The gripper and plucker assemblies move away from each other to remove the pit from the fruit and may be cleaned after pitting a number of fruits. A process for pitting a fruit comprising orienting the fruit, grabbing the fruit with a gripper assembly, grabbing an end portion of a seed of the fruit, and moving the gripper assembly and the plucker assembly away from each other.

### CROSS-REFERENCE TO RELATED APPLICATIONS

This application claims the benefit of U.S. patent application 63/667,694, filed Jul. 3, 2024, which is incorporated by reference along with all other references cited in this application.

### BACKGROUND OF THE INVENTION

The present disclosure relates to removing pits, seeds or stones (collectively pit for singular reference or pits for plural reference hereinafter) from drupaceous fruit, and more specifically, to soft, juicy, and fruit varieties such as dates, prunes, cherries, apricots, peaches, and others. More particularly, the present disclosure relates to improvements in methods and apparatuses for pitting fruits (e.g., removing pits from fruits).

Soft and juicy fruits such as date varieties (e.g., Medjool, Mazafati, Barhi, and others), prunes, cherries, apricots, apriums, peaches, and others are highly popular worldwide due to their rich, sweet flavors and versatile culinary uses. These varieties are not only enjoyed fresh but are also highly sought after for pitted and stuffed products, which are more convenient for consumers. The importance of removing pits from such fruits cannot be overstated, as whole fruits with pits pose a risk of dental damage to consumers and can harm the reputation of date processors or producers, or a combination. Furthermore, the current low profit margins in producing pitted fruits make it imperative to develop more cost-effective technologies to enhance profitability while maintaining high product quality.

Some conventional approaches manually remove pits from such fruits. Nonetheless, the manual pitting of these soft, fragile fruits is not only labor-intensive but also poses significant food safety challenges and concerns such as contamination and thus significantly increases operational costs. Some legacy approaches use punch-type pitters and low-grade indexing machines that have been proven to be ineffective for softer fruits such as dates because these pitters often damage the skin and even the flesh of the fruit, leading to significant wastage and reduced product quality as well as reduced profit margin. Moreover, this punch-type process is particularly laborious and time-consuming, contributing to higher production costs and making it even more difficult to meet market demand efficiently.

Therefore, there is a need for improved methods and apparatuses for pitting fruits, and especially a growing need for advanced pitting technology that lowers production costs, reduces pit count, and ensures high-quality pitted fruits.

### BRIEF SUMMARY OF THE INVENTION

A pitting head assembly of an apparatus that grabs onto a fruit (e.g., Medjool or other date) with a gripper assembly in the pitting head assembly and further grabs onto an end portion of the pit near the calyx of the fruit with a plucker assembly in the pitting head assembly. The gripper and plucker assemblies move away from each other to remove the pit from the fruit and may be cleaned after pitting a number of fruits. A process for pitting a fruit comprising orienting the fruit, grabbing the fruit with a gripper assembly, grabbing an end portion of a seed of the fruit, and moving the gripper assembly and the plucker assembly away from each other.

Various embodiments are directed to apparatuses and methods for removing pits from fruits. Some embodiments are directed to an apparatus for removing pits from fruits. The apparatus includes a conveyor belt that comprises a slot or a recessed area, wherein the slot or the recessed area accommodates a fruit to be pitted and a pitting head assembly that comprises a gripper assembly and a plucker assembly and is operatively coupled with the conveyor belt to receive the fruit into the pitting head assembly in these embodiments. The apparatus further comprises a guarding that encloses at least a portion of the pitting head assembly; and a device that converts an electrical energy input into a mechanical energy output and is operatively coupled with the pitting head assembly to drive the gripper assembly and the plucker assembly.

In some of these embodiments, the pitting head assembly comprises a gripper actuator cam that is operatively coupled to the device to receive the mechanical energy output, wherein the mechanical energy output causes the gripper actuator cam to rotate around a gripper actuator cam axis; and a plucker actuator cam that is operatively coupled to the device to receive the mechanical energy output, wherein the mechanical energy output causes the plucker actuator cam to rotate around a plucker actuator cam axis.

In some of the immediately preceding embodiments, the plucker actuator cam comprises a plucker actuator cam profile surface that is in contact with a first end portion of the plucker assembly, wherein the plucker assembly comprises a plucker assembly jaw that comprises a plurality of plucker fingers. Moreover, the gripper actuator cam comprises a gripper actuator cam profile surface that is in contact with a first end portion of the gripper assembly, wherein the gripper assembly comprises a gripper assembly jaw that comprises three or more gripper fingers.

In some of the immediately preceding embodiments, the plucker assembly comprises a plucker jaw at a first end of the plucker assembly and a plucker jaw open and close plunger at a second end of the plucker assembly. Moreover, the plucker jaw comprises a plurality of plucker fingers at a first end of the plucker assembly. In addition, a plucker finger of the plurality of plucker fingers comprises at least one tooth.

In some of the immediately preceding embodiments, a plucker jaw actuator that is operatively coupled with the plucker jaw open and close plunger and the plurality of plucker fingers of the plucker jaw, wherein the plucker jaw actuator comprises a same number of curved geometric features that respectively correspond to the plurality of plucker fingers, actuation of the plucker jaw open and close plunger using the plucker actuator cam opens the plurality of plucker fingers, and release of the plucker jaw open and close plunger using the plucker actuator cam closes the plurality of plucker fingers.

In some embodiments, the gripper assembly comprises a gripper jaw at a first end of the gripper assembly and a gripper jaw open and close plunger at a second end of the gripper assembly. In addition, the gripper jaw comprises three or more gripper fingers at a first end of the gripper assembly, and a gripper finger of the plurality of gripper fingers comprises a profile that includes multiple different widths without sharp corners when transitioning among the multiple different widths.

In some of the immediately preceding embodiments, the gripper assembly may include a gripper jaw actuator that is operatively coupled with the gripper jaw open and close plunger and the three or more gripper fingers of the gripper jaw, wherein the gripper jaw actuator comprises a same number of curved geometric features that respectively correspond to the three or more gripper fingers, actuation of the gripper jaw open and close plunger using the gripper actuator cam opens the three or more gripper fingers, and release of the gripper jaw open and close plunger using the gripper actuator cam closes the three or more gripper fingers.

In some embodiments, the gripper assembly comprises a gripper jaw at a first end of the gripper assembly and a gripper jaw open and close plunger at a second end of the gripper assembly, the gripper jaw comprises three or more gripper fingers at a first end of the gripper assembly, and a gripper finger of the three or more gripper fingers comprises a plurality of widths without sharp corners when transitioning among the plurality of widths.

In some embodiments, the gripper assembly is substantially aligned with the plucker assembly along an axial direction along which both the gripper assembly and the plucker assembly move.

In some embodiments, the system may further include an electronic control subsystem that is operatively coupled to the pitting head assembly and the conveyor belt and further comprises a first speed control circuit that is operatively coupled with and controls an operational speed of the conveyor belt using a first variable frequency drive based at least in part upon an input at an operator interface; and a second speed control circuit that is operatively coupled with and controls an operational speed of the pitting head using a second variable frequency drive.

In some of the immediately preceding embodiments, the electronic control subsystem further comprises a pneumatic control device that controls operations of a pneumatic device in the system based at least in part upon a first output of a first detector, a first gauge, or a first sensor; an electrical control device that controls operations of an electrical device in the system based at least in part upon a second output of a second detector, a second gauge, or a second sensor; and one or more safety interlocks that disable at least a portion of the system based at least in part upon an output or a state of a safety switch, an optical safety device, a safety detector, or a safety lock.

In addition or in the alternative, the electronic control subsystem further comprises a singulation control device that controls a singulator based at least in part upon an output of a first optical sensor or a first machine vision device, wherein the singulator operates to eliminate or reduce a stacked fruit that is stacked on top of or above the fruit that is in direct contact with the conveyor belt.

In addition or in the alternative, the electronic control subsystem further comprises an orientation control device that controls an orientor based at least in part upon an output of a second optical sensor or a second machine vision device, wherein the orientor operates to orient a stacked fruit so that a calyx end of the fruit faces the plucker assembly.

In some embodiments, the system may include a loading hopper that is operatively coupled with the conveyor belt, wherein the fruit is automatically transported from the loading hopper to the pitting head assembly via the conveyor belt; and a level, volume, or quantity sensor that monitors a level, volume, or quantity of fruits in the loading hopper, wherein the loading hopper is further operatively coupled with an upstream conveyor that replenishes contents of the loading hopper based at least in part upon an output of the level, volume, or quantity sensor.

In some embodiments, the system may include a plurality of plucker assemblies that is arranged in a pattern; a plucker actuator cam that drives a plucker assembly of the plurality of plucker assemblies when the plucker assembly makes a direct contact and releases the direct with the plucker actuator cam; a plurality of gripper assemblies that is arranged in the pattern in which the plurality of plucker assemblies is also arranged; a gripper actuator cam that drives a gripper assembly of the plurality of gripper assemblies when the gripper assembly makes a direct contact and releases the direct with the gripper actuator cam, wherein movements of the plurality of gripper assemblies controlled by the gripper actuator cam is synchronized with movements of the plurality of plucker assemblies controlled by the plucker actuator cam.

Some embodiments are directed to a method for removing pits. In these embodiments, a fruit on a conveyor belt may be received in a pitting head assembly. A gripper assembly may be actuated to grab at least an end portion up to an entire portion of the fruit using a gripper assembly jaw having three or more gripper fingers, wherein the end of the fruit is opposite to a calyx end near the calyx of the fruit. A plucker assembly may also be actuated to grab an end portion of a pit of the fruit using a plucker assembly jaw having a plurality of plucker fingers, wherein a plucker finger comprises one or more teeth that cut through an epicarp of the fruit to grab the end portion of the pit. The pit may be removed from the fruit at least by moving the gripper assembly or the plucker assembly away from one another.

In some of the immediately preceding embodiments, the gripper assembly may be cleaned at least by dispensing a cleansing fluid onto at least a portion of the gripper assembly, after the gripper assembly releases a pitted fruit of the fruit; or the plucker assembly may be cleaned at least by dispensing the cleansing fluid onto at least a portion of the plucker assembly, after the plucker assembly releases the pit.

In some embodiments, the plucker assembly may be moved toward the fruit on the conveyor belt. The plurality of plucker fingers of the plucker assembly jaw may be opened at least by actuating a plucker jaw actuator of the plucker assembly with a plucker assembly open and close plunger. The plucker assembly may be stopped at a plucker stop position. The plurality of plucker fingers of the plucker assembly jaw may be closed at least by releasing the plucker jaw actuator of the plucker assembly with the plucker assembly open and close plunger.

In some embodiments, the gripper assembly may be moved or driven toward the fruit on the conveyor belt. The three or more gripper fingers of the gripper assembly jaw may be opened at least by actuating a gripper jaw actuator of the gripper assembly with a gripper assembly open and close plunger. The gripper assembly may be stopped at a gripper stop position, and the three or more gripper fingers of the gripper assembly jaw may be closed at least by releasing the gripper jaw actuator of the gripper assembly with the gripper assembly open and close plunger.

In some embodiments, a plurality of fruits on the conveyor belt may be singulated to eliminate or at least reduce a number of stacked fruits that is stacked on top of or above the fruit that is in direct contact with the conveyor belt.

In some embodiments, the fruit may be oriented on the conveyor belt so that a calyx end near a calyx of the fruit is facing the plucker assembly when the plucker assembly moves or is to move toward the fruit for pit removal, wherein a first end of the fruit opposing the calyx end is facing the gripper assembly when the plucker assembly or the gripper assembly moves or is to move toward the fruit for the pit removal.

Some embodiments are directed to a pitting head system for removing a pit from a fruit, and the pitting head system may include a plucker assembly, a plucker actuator cam that drives the plucker assembly when the plucker assembly makes a first direct contact and releases the first direct with the plucker actuator cam, a gripper assembly, and a gripper actuator cam that drives the gripper assembly when the gripper assembly makes a second direct contact and releases the second direct with the gripper actuator cam.

In some of the immediately preceding embodiments, the pitting head system may also include a plurality of plucker assemblies that is arranged in a pattern, wherein the plucker actuator cam that drives each plucker assembly of the plurality of plucker assemblies when the each plucker assembly makes the first direct contact and releases the first direct contact with the plucker actuator cam.

In some of the immediately preceding embodiments, the pitting head system may further include a plurality of gripper assemblies that is arranged in the pattern in which the plurality of plucker assemblies is also arranged, wherein the gripper actuator cam drives each gripper assembly of the plurality of gripper assemblies when the each gripper assembly makes the second direct contact and releases the second direct contact with the gripper actuator cam, and movements of the plurality of gripper assemblies controlled by the gripper actuator cam are synchronized with movements of the plurality of plucker assemblies controlled by the plucker actuator cam.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1A shows a top view of an example pitting apparatus paired with a loading hopper in some embodiments.

FIG. 1B shows a top view of another example pitting apparatus paired with a loading hopper in some embodiments.

FIG. 2A shows an isometric view of the example pitting apparatus paired with the loading hopper shown in FIG. 1A in some embodiments.

FIG. 2B shows an isometric view of the example pitting apparatus paired with the loading hopper shown in FIG. 1B in some embodiments.

FIG. 2C shows another isometric view of the example pitting apparatus paired with the loading hopper shown in FIG. 1B in some embodiments.

FIG. 3 shows an example anatomy of a fruit in some embodiments.

FIGS. 4A-4C show an example of a gripper assembly and a plucker assembly acting upon a date to remove the pit from the date, according to some embodiments of the present disclosure.

FIG. 5A shows a side view of a first example plucker assembly that may be used in an apparatus for pitting fruits, according to some embodiments.

FIG. 5B shows a cross-sectional view of the first example plucker assembly shown in FIG. 5A, according to some embodiments.

FIG. 5C shows a side view of a second example plucker assembly that may be used in an apparatus for pitting fruits, according to some embodiments.

FIG. 5D shows a cross-sectional view of the second example plucker assembly shown in FIG. 5A, according to some embodiments.

FIG. 6A shows a side view of a first example gripper assembly that may be used in an apparatus for pitting fruits, according to some embodiments.

FIG. 6B shows a cross-sectional view of the first example gripper assembly shown in FIG. 6A, according to some embodiments.

FIG. 6C shows a side view of a second example gripper assembly that may be used in an apparatus for pitting fruits, according to some embodiments.

FIG. 6D shows a cross-sectional view of the second example gripper assembly shown in FIG. 6A, according to some embodiments.

FIG. 7A shows a cross-sectional view of the example pitting head assembly shown in FIG. 1A or 2A, according to some embodiments.

FIG. 7B shows an isometric view of the example pitting head assembly shown in FIG. 1A or 2A, according to some embodiments.

FIG. 7C shows a cross-sectional view of the example pitting head assembly shown in FIG. 1B or 2B-2C, according to some embodiments.

FIG. 7D shows an isometric view of the example pitting head assembly shown in FIG. 1B or 2B-2C, according to some embodiments.

FIG. 7E shows a side view of the example pitting head assembly shown in FIG. 1B at a time instant, according to some embodiments.

FIG. 7F shows a side view of the example pitting head assembly shown in FIG. 7C, according to some embodiments.

FIG. 8A shows an example block diagram of an apparatus in which some of various techniques described herein for pitting fruits with the example pitting apparatus shown in FIG. 1A may be implemented, according to some embodiments.

FIG. 8B shows an example block diagram of an apparatus in which some of various techniques described herein for pitting fruits with the example pitting apparatus shown in FIG. 1B or 2B-2C may be implemented, according to some embodiments.

FIG. 9 shows more details about a portion of FIG. 8, according to some embodiments.

FIG. 10 shows more details about a portion of FIG. 9, according to some embodiments.

FIG. 11 shows a block diagram for pitting fruits, according to some embodiments.

FIG. 12 shows an example block diagram for singulation, according to some embodiments.

FIG. 13 shows a simplified example portion of a conveyor belt carrying singulated fruits for pitting the fruits, according to some embodiments.

FIG. 14 shows an example of feeding a conveyor belt with a loading hopper and an example method for achieving singulation, according to some embodiments.

FIG. 15 shows a simplified schematic diagram of a portion of an example pitting head assembly of an apparatus for pitting fruits, according to some embodiments.

FIGS. 16A-16H show some simplified example pitting operations of a gripper assembly and a plucker assembly for fruits carried by a conveyor belt, according to some embodiments.

FIG. 17 shows a simplified example of a conveyor belt having a plurality of flights or slots carrying some fruits on the conveyor belt for pit removal, according to some embodiments.

### DETAILED DESCRIPTION OF THE INVENTION

Various embodiments described herein are directed to methods and apparatus for pitting fruits. Some embodiments described herein are directed to an apparatus described in this invention is designed to handle a vast variety of fruit varieties, ranging from those with soft, high-moisture skin to those with harder, drier skin. Soft-skinned, high-moisture fruits such as Medjool dates are notoriously difficult to pit with traditional methods. Other fruit varieties that may benefit from the apparatus include prunes, apricots, apriums, peaches, Mazafati dates, known for its juicy and soft flesh; Barhi dates, which transitions from crunchy to chewy as it ripens, Khola dates, which has a sticky and soft texture, Halawi dates, with its moderately fibrous yet firm consistency, Sukkary dates, prized for its very soft and honey-like texture, Khudri dates, with its soft, chewy flesh and slightly wrinkled skin, and others. The present disclosure provides a solution for efficiently and gently pitting fruits, addressing the limitations of existing technologies that struggle with such textures and moisture levels.

The manual pitting of dates is not only labor-intensive but also presents significant food safety challenges and high operational costs. Handling dates manually requires a substantial workforce, which increases labor costs and can lead to inconsistencies in the quality of the pitted dates. On average, a person can pit only about 10 pounds of dates per hour manually, making it a slow and inefficient process Furthermore, the manual process can pose food safety risks as it involves direct human contact with the fruit, increasing the potential for contamination.

Automated pitting machines provide a solution to these challenges by improving efficiency, ensuring consistency, and reducing the risk of contamination. These machines can process dates much faster than manual methods, significantly reducing labor costs. They also minimize human contact with the dates, thereby enhancing food safety by preventing the introduction of contaminants. Moreover, automated machines are designed to handle the delicate nature of dates, ensuring the fruit remains intact and undamaged during the pitting process.

In the description that follows, the present invention will be described in reference to embodiments. However, embodiments of the invention are not limited to any particular environment, application, or implementation. For example, although different techniques of pitting fruits will be described, the invention is not limited to the specific embodiments described below. Therefore, the description of the embodiments that follows is for purposes of illustration and not limitation. Further, any embodiment or even a feature thereof described herein can be readily combined with any other embodiment or embodiments or feature thereof described herein or equivalents thereof, unless otherwise explicitly disclaimed or described as mutually exclusive of one another. Moreover, examples of embodiments of the invention are shown using figures and are described below. The figures described herein are used to show embodiments of the invention, and are not in any way intended to be restrictive of the broad invention. Embodiments of the invention are not limited to the specific arrangements and constructions shown and described. For example, features shown in one figure can be combined with features shown in another figure.

Some embodiments described herein are directed to an apparatus that handles a variety of date types, from soft, high-moisture varieties (e.g., Medjool dates) to those with firmer textures. These embodiments address the laborious, costly, and food safety challenges associated with manual pitting, offering an efficient, safe, and cost-effective alternative for the date processing industry.

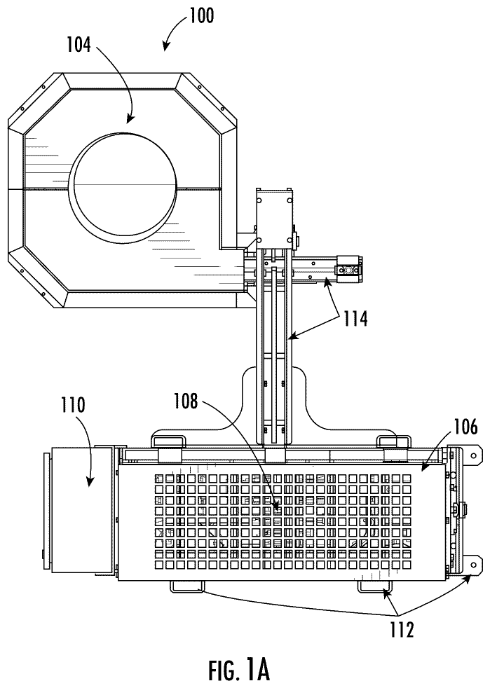

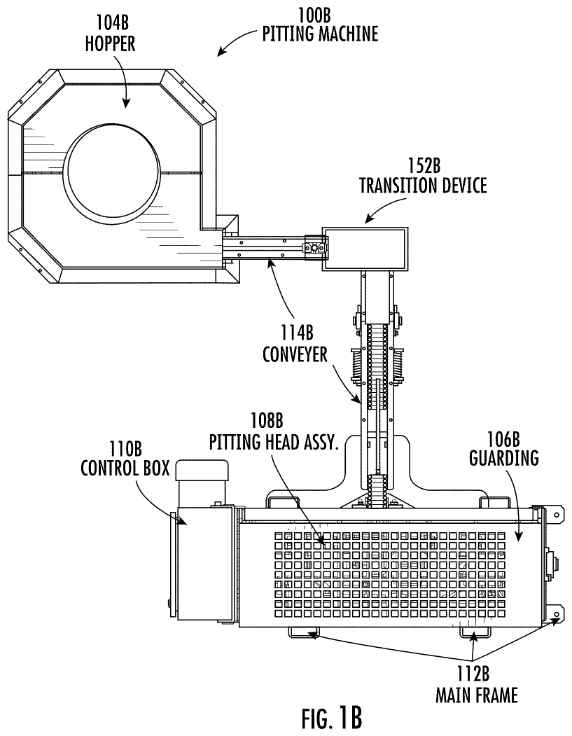

FIG. 1A shows a top view of an example pitting apparatus paired with a loading hopper in some embodiments. More specifically, the example pitting apparatus 100 includes a pitting head assembly 108 that is at least partially enclosed in the guarding 106 to prevent bodily contact and hence injuries with various moving mechanisms thereof and is devised to remove pits, seeds or stones (collectively pit for singular reference or pits for plural reference hereinafter) from drupaceous fruits such as dates, prunes, cherries, apricots, peaches, and others.

The pitting head assembly 108 and the guarding 106 at least partially enclosing the pitting head assembly 108 may be removably or fixedly mounted on a main frame 112 in such a way that various interfaces, knobs, switches, or any components that need to be accessed for the operation of the pitting apparatus 100, services, or maintenance, and the like may be ergonomically placed for operators of an average build (e.g., 75 percentile of an adult male or female operator).

In some embodiments, the pitting head assembly 108 at least partially enclosed in the guarding 106 may receive fruits from a conveyor 114 which transports the fruits to be pitted into the pitting head assembly 108 which performs various functions described herein to remove the pits from the fruits. In some embodiments, the conveyor 114 may receive fruits from one or more operators who manually load the fruits onto the conveyor 114 which in turn transports the manually loaded fruits to the pitting head assembly 108. In some other embodiments, the conveyor 114 may receive fruits to be pitted from a loading hopper 104 which includes, for example, a container for a bulk material such as fruits, grain, and the like and may include a space that holds the bulk material and is able to discharge its contents at the bottom or the side.

In some embodiments, the loading hopper 104 may be equipped a level or volume sensor that measures the level or amount of fruits in the loading hopper 104 where the sensor may be triggered to send a signal or instruction to another conveyor to replenish the fruits in the loading hopper 104 when the level or amount drops below a certain limit. In some of these embodiments, the loading hopper 104 may be equipped with another sensor which may be triggered to send another signal or instruction to stop the aforementioned conveyor from replenishing the fruits in the loading hopper 104 to prevent over filling the loading hopper 104 so that the fruits near the bottom of the loading hopper 104 may be subject to larger than desired or required load from the over-filled fruits on top that may cause damage to the fruits at or near the bottom of the loading hopper 104.

The main frame 112 may also support a control box 110 enclosing therein various electrical, pneumatic, fluid, optical, or mechanical control mechanisms, or a combination, that facilitate the efficient, effective operations of the pitting apparatus 100. For example, the control box 110 may provision various controls that synchronizes the operations of the pitting head assembly 108 that removes the pits from the fruits and the operations of the conveyor 114. For example, the conveyor assembly 114 or the conveyor belt therein may be timed with the pitting head assembly 108 to avoid, eliminate, or at least reduce undesired wait time or under-utilization of the conveyor assembly 114 or the pitting head assembly 108, or a combination, as well as mismatched operational speeds when one of the two aforementioned assemblies operates at a speed that the other of the two aforementioned assemblies is unable to catch up with. More details about the control box 110 as well as the operations of the pitting head assembly 108 and those of the conveyor 114 will be described below.

FIG. 1B shows a top view of an example pitting apparatus paired with a loading hopper in some embodiments. More specifically, the example pitting apparatus 100B includes a pitting head assembly 108B that is at least partially enclosed in the guarding 106B to prevent bodily contact and hence injuries with various moving mechanisms thereof and is devised to remove pits, seeds or stones (collectively pit for singular reference or pits for plural reference hereinafter) from drupaceous fruits such as dates, prunes, cherries, apricots, peaches, and others. The pitting head assembly 108B and the guarding 106B in FIG. 1B may be identical to, substantially similar to, or different from the pitting head assembly 108 and the guarding 106 in FIG. 1A, depending on the design requirements for fit and functionality.

The pitting head assembly 108B and the guarding 106B at least partially enclosing the pitting head assembly 108B may be removably or fixedly mounted on a main frame 112B in such a way that various interfaces, knobs, switches, or any components that need to be accessed for the operation of the pitting apparatus 100B, services, or maintenance, and the like may be ergonomically placed for operators of an average build (e.g., 75 percentile of an adult male or female operator).

In some embodiments, the pitting head assembly 108B at least partially enclosed in the guarding 106B may receive fruits from a conveyor 114B of the transition device 152B (transitioning from the hopper 104B to the pitting head assembly 108B) which transports the fruits to be pitted into the pitting head assembly 108B inside the guarding 106B which is mounted directly or indirectly on the main frame 112B and performs various functions described herein to remove the pits from the fruits. In some embodiments, the conveyor 114B of the transition device 152B may receive fruits from one or more operators who manually load the fruits onto the conveyor 114B which in turn transports the manually loaded fruits to the pitting head assembly 108B. In some other embodiments, the conveyor 114B may receive fruits to be pitted from a loading hopper 104B which includes, for example, a container for a bulk material such as fruits, grain, and the like and may include a space that holds the bulk material and is able to discharge its contents at the bottom or the side.

In some embodiments, the loading hopper 104B may be equipped a level or volume sensor that measures the level or amount of fruits in the loading hopper 104B where the sensor may be triggered to send a signal or instruction to another conveyor to replenish the fruits in the loading hopper 104B when the level or amount drops below a certain limit. In some of these embodiments, the loading hopper 104B may be equipped with another sensor which may be triggered to send another signal or instruction to stop the aforementioned conveyor from replenishing the fruits in the loading hopper 104B to prevent over filling the loading hopper 104B so that the fruits near the bottom of the loading hopper 104B may be subject to larger than desired or required load from the over-filled fruits on top that may cause damage to the fruits at or near the bottom of the loading hopper 104B.

The main frame 112B may also support a control box 110B enclosing therein various electrical, pneumatic, fluid, optical, or mechanical control mechanisms, or a combination, that facilitate the efficient, effective operations of the pitting apparatus 100B. For example, the control box 110B may provision various controls that synchronizes the operations of the pitting head assembly 108B that removes the pits from the fruits and the operations of the conveyor 114B. For example, the conveyor assembly 114B or the conveyor belt therein may be timed with the pitting head assembly 108B to avoid, eliminate, or at least reduce undesired wait time or under-utilization of the conveyor assembly 114B or the pitting head assembly 108B, or a combination, as well as mismatched operational speeds when one of the two aforementioned assemblies operates at a speed that the other of the two aforementioned assemblies is unable to catch up with. More details about the control box 110B as well as the operations of the pitting head assembly 108B and those of the conveyor 114B will be described below.

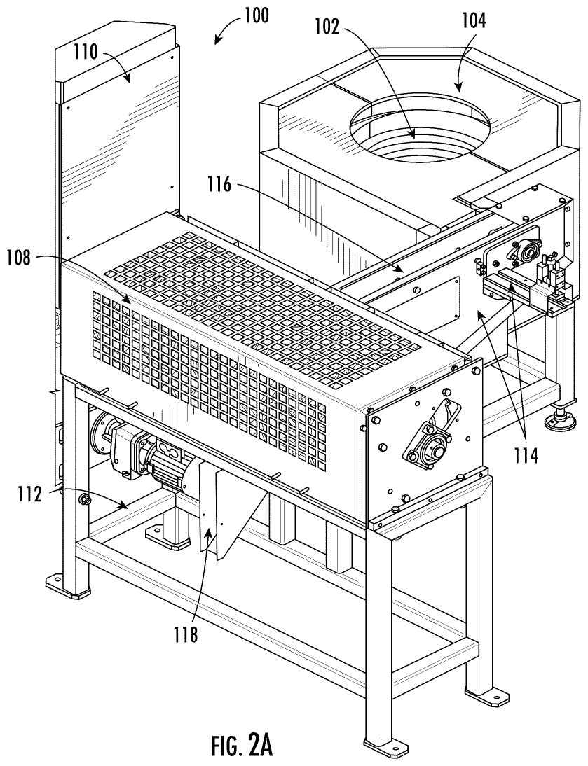

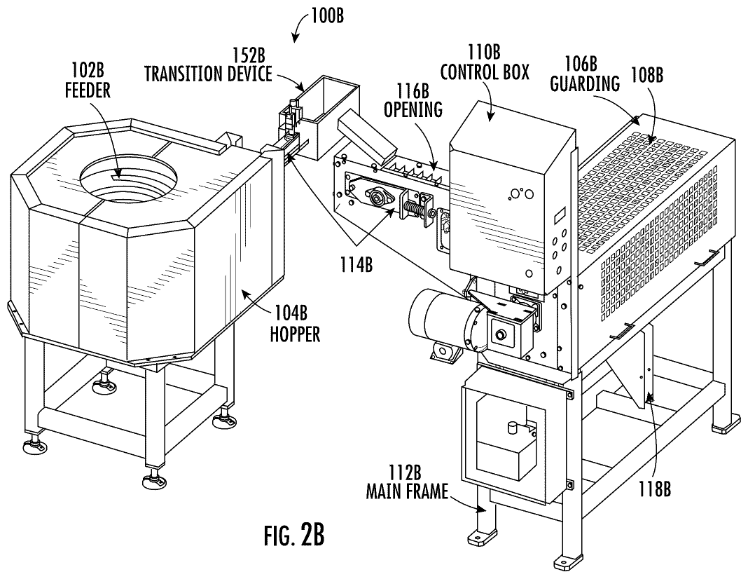

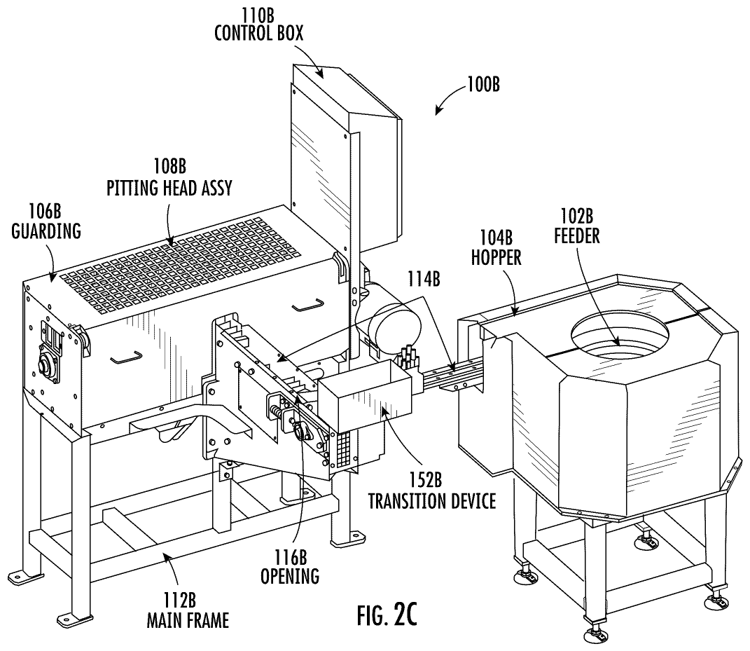

FIG. 2A shows an isometric view of the example pitting apparatus paired with the loading hopper shown in FIG. 1A in some embodiments. In these embodiments, the pitting apparatus 100 includes the main frame 112 that supports the guarding 106 for the pitting head assembly 108 (at least partially enclosed in the guarding 106) as well as the control box 110. The pitting head assembly 108 receives fruits from the conveyor 114.

In some of the embodiments, the enclosure of the conveyor 114 may include an opening 116 that exposes at least one fruit on a conveyor belt (not shown) of the conveyor 114. In these embodiments, the opening 116 may allow an operator to manipulate the fruit. The conveyor 114 may receive fruits either through manual loading or via a loading hopper 104 which may include a feeder 102 for the loading hopper 104. The pitting head assembly 108 at least partially enclosed in the guarding 106 may be operatively coupled to a discharge channel 118 that guides pitted fruits out of the guarding 106 for the pitting head assembly 108 for collection, package, storage, and the like.

FIG. 2B shows an isometric view of another example pitting apparatus paired with the loading hopper shown in FIG. 1B in some embodiments. In these embodiments, the pitting apparatus 100B includes the main frame 112B that supports the guarding 106B for the pitting head assembly 108B (at least partially enclosed in the guarding 106B) as well as the control box 110B. The pitting head assembly 108B receives fruits from the conveyor 114B of the transition device 152B transitioning fruits from the hopper assembly 104B to the pitting head assembly 108B.

In some of the embodiments, the enclosure of the conveyor 114B may optionally include an opening 116B that exposes at least one fruit on a conveyor belt (not shown) of the conveyor 114B. In these embodiments, the optional opening 116B may allow an operator to manipulate the fruit. The conveyor 114B may receive fruits either through manual loading or via a loading hopper 104B which may include a feeder 102B for the loading hopper 104B. The pitting head assembly 108B at least partially enclosed in the guarding 106B may be operatively coupled to a discharge channel 118B that guides pitted fruits out of the guarding 106B for the pitting head assembly 108B for collection, package, storage, and the like.

FIG. 2C shows another isometric view of the example pitting apparatus paired with the loading hopper shown in FIG. 1B in some embodiments. In these embodiments, the pitting apparatus 100B includes the main frame 112B that supports the guarding 106B for the pitting head assembly 108B (at least partially enclosed in the guarding 106B) as well as the control box 110B. The pitting head assembly 108B receives fruits from the conveyor 114B of the transition device 152B transitioning fruits from the hopper assembly 104B to the pitting head assembly 108B.

In some of the embodiments, the enclosure of the conveyor 114B may optionally include an opening 116B that exposes at least one fruit on a conveyor belt (not shown) of the conveyor 114B. In these embodiments, the optional opening 116B may allow an operator to manipulate the fruit. The conveyor 114B may receive fruits either through manual loading or via a loading hopper 104B which may include a feeder 102B for the loading hopper 104B. The pitting head assembly 108B at least partially enclosed in the guarding 106B may be operatively coupled to a discharge channel 118B (shown in FIG. 2B) that guides pitted fruits out of the guarding 106B for the pitting head assembly 108B for collection, package, storage, and the like.

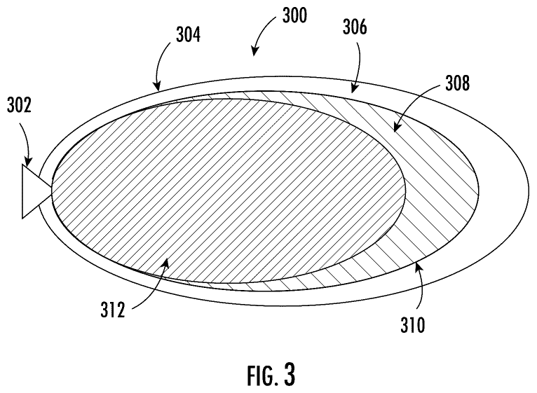

FIG. 3 shows an example anatomy of a fruit in some embodiments. In this example, the fruit 300 may include the epicarp 304 with a calyx 302 on one end. The calyx 302 is the whorl of a flower consisting of separate or fused sepals (one of the modified leaves comprising a calyx). The epicarp 304 is the outermost layer of the pericarp of the fruit 300. A pericarp includes the ripened and variously modified walls of a plant ovary composed of an outer exocarp, middle mesocarp, and inner endocarp layer. An exocarp is the outermost layer of the pericarp of the fruit 300. The endocarp is the inner layer of the pericarp of a fruit (such as an apple or orange) when it consists of two or more layers of different texture or consistency. Under the epicarp 304 lies the mesocarp (e.g., pulp) which is the middle layer of the pericarp. Under the mesocarp 304 may be an annular space 308 for fruits such as some dates, apricots, and others.

At the innermost lies the pit 312 which may be removed using various techniques and apparatuses described herein and may also be referenced as a kernel or seed in some cases. A seed may include the grains or ripened ovules of plants used for sowing in some embodiments or the fertilized ripened ovule of a flowering plant comprising an embryo and capable normally of germination to produce a new plant. A pit may include the stone of a drupaceous fruit while a kernel includes the softer part of a seed, fruit stone, or nut.

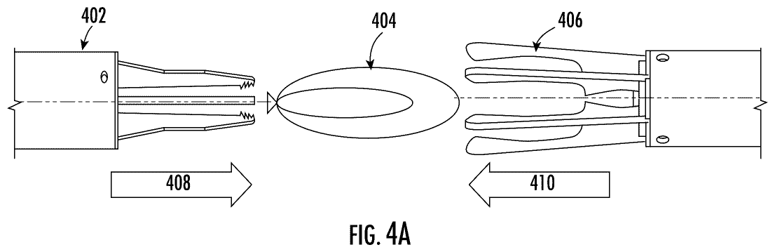

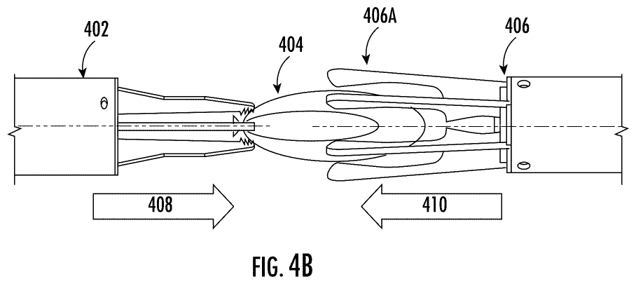

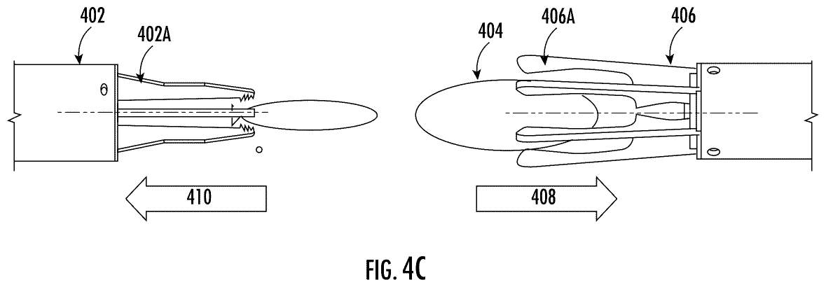

FIGS. 4A-4C show an example of a gripper assembly and a plucker assembly acting upon a date to remove the pit from the date, according to some embodiments of the present disclosure. FIG. 4A shows an example where a plucker assembly 402 (only a portion is shown) and a gripper assembly 406 (also only a portion is shown) are positioned to remove the pit of a fruit 404. In operation, the plucker assembly 402 moves towards the fruit 404 along the direction 408, and the gripper assembly 406 moves towards the fruit 404 along the direction 410 to engage with the fruit 404 to remove its pit.

FIG. 4B shows the example where the gripper assembly 406 has moved to a position and closes the jaw 406A to secure the fruit 404 with its jaw 406A. The gripper assembly 406 may be devised in such a way to stop at a fixed position regardless of the position of the fruit 404 in some embodiments or at a relative stop position relative to the actual position of the fruit in some other embodiments.

For example, a gripper assembly 406 may be devised to travel a fixed distance from its fully retracted position in some embodiments while the fixed distance is determined in such a way that the gripper assembly 406 will certainly or more likely than not be able to secure the fruit with its jaw 406A.

As another example, the gripper assembly may be devised to travel a variable distance, depending upon the actual position of the fruit, while ensuring that the gripper assembly will certainly or more likely than not be able to secure the fruit with its jaw 406A. The stop position may be a physical stop (e.g., using a physical object to stop the axial movement of the gripper assembly 406) in some embodiments or an electronically determined stop in some other embodiments.

The plucker assembly 402 may also be devised in such a way to stop at a fixed position regardless of the position of the fruit 404 in some embodiments or at a relative stop position relative to the actual position of the fruit in some other embodiments.

For example, a plucker assembly 402 may be devised to travel a fixed distance from its fully retracted position in some embodiments while the fixed distance is determined in such a way that the plucker assembly 402 will certainly or more likely than not be able to grab the end of the pit from the calyx end with its jaw 406A for removal.

As another example, the plucker assembly 402 may be devised to travel a variable distance, depending upon the actual position of the fruit, while ensuring that the plucker assembly 402 will certainly or more likely than not be able to grab the end of the pit from the calyx end with its jaw 406A for removal. The stop position may be a physical stop (e.g., using a physical object to stop the axial movement of the plucker assembly 402) in some embodiments or an electronically determined stop in some other embodiments.

FIG. 4C shows the same example shown in FIGS. 4A-4B. More specifically, the plucker assembly 402 securely grabs the calyx end with its jaw 402A while the gripper assembly 406 secures the fruit 404 with its jaw 406A. Once the fruit 404 is secured with both the plucker assembly 402 and the gripper assembly 406, the plucker assembly 402 retracts along the direction 410 with its jaw 402A grabbing the pit, and the gripper assembly 406 retracts along the direction 408 with its jaw 406A grabbing the fruit 404.

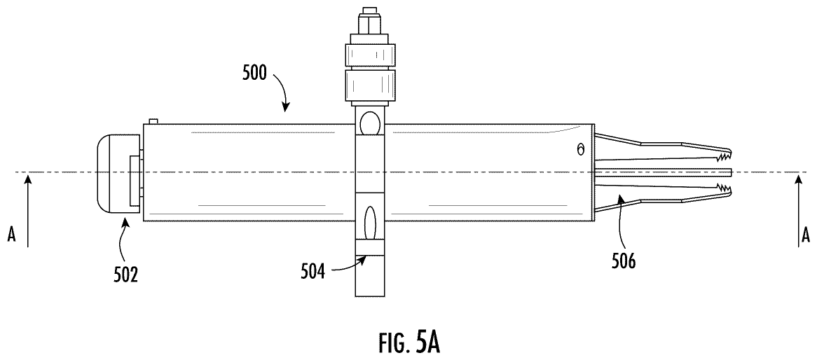

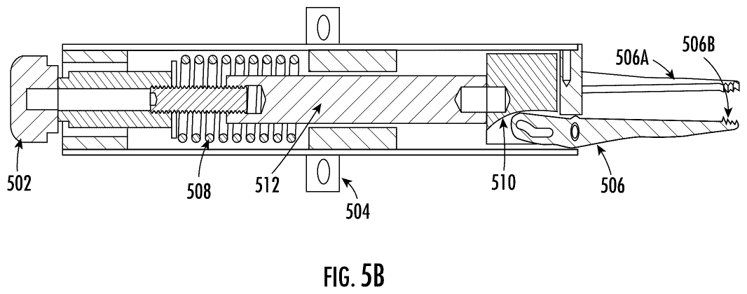

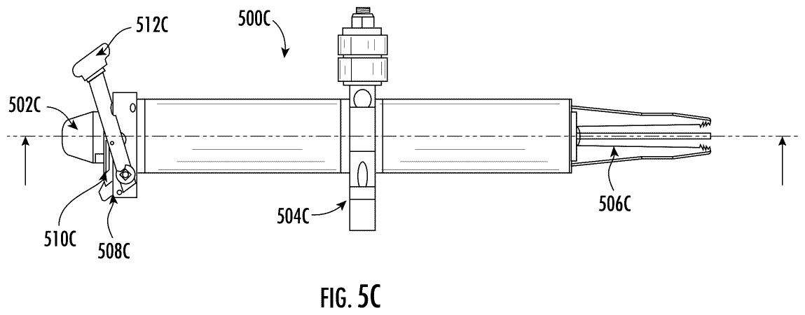

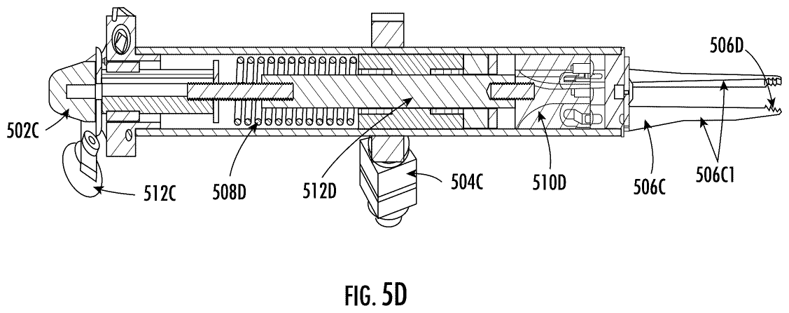

FIG. 5A shows a side view of an example plucker assembly that may be used in an apparatus for pitting fruits, according to some embodiments. In these embodiments, the plucker assembly 500 includes a jaw 506 which is actuated to open and close by a plunger 502. The plucker assembly 500 may be further fixedly or removably attached to a cam block 504 which controls the advancement and retraction of the plucker assembly 500. A cam includes a mechanism that translates motion in some embodiments. For example, a cam may include a rotating or sliding component in a mechanical linkage used especially in transforming rotary motion into linear motion.

The jaw 506 is devised to grab one end of a pit when the plucker assembly 500 advances with its jaw 506 open to engage with the calyx end of a fruit, and the jaw 506 closes when the plucker assembly 500 is at the designated stop position. The advancement and retraction of the plucker assembly 500 may be guided by a cam block 504 which is in turn actuated upon by a cam. The open and close actions of the plucker assembly 500 may be controlled by the plunger 502.

FIG. 5B shows a cross-sectional view of the example plucker assembly shown in FIG. 5A, according to some embodiments. More specifically, the plucker assembly (e.g., reference numeral 500 in FIG. 5A) includes an open-close plunger 502 which is operatively coupled with a return spring 508 that is further operatively coupled with a guide rod 512 on one end so that the open-close plunger 502, when actuated, pushes the guide rod 512 with the spring force of the return spring 508 and returns the guide rod 512 to its neutral or closed position when the spring force of the return spring 508 is released.

Another end of the guide rod 512 is operatively coupled with (e.g., fixedly or removably attached) to a plucker jaw actuator 510. The plucker jaw actuator 510 includes a corresponding geometric feature that respectively mates with a jaw finger 506A of the jaw so that with the advancement and retraction of the plucker jaw actuator 510, the corresponding geometric feature causes the jaw finger 506A to open and close. A jaw finger 506A may include one or more teeth 506B on the free-tip end (e.g., the end away from the open-close plunger 502) so that the one or more teeth 506B secure a pit. In some embodiments, a gripper assembly jaw comprises three or more fingers. In one embodiment, a gripper assembly jaw comprises four fingers while in another embodiment, a gripper assembly jaw comprises six fingers. In some embodiments, a plucker assembly jaw comprises three or more fingers. In some embodiments, the figures are in direct contact with fruit and may be made of, for example but not limited to, any FDA (Food and Drug Administration) approved materials such as any food grade material with sufficient properties (e.g., tensile or compressive strength, manufacturability, wear resistance, or a combination, and others) or any other required or desired materials.

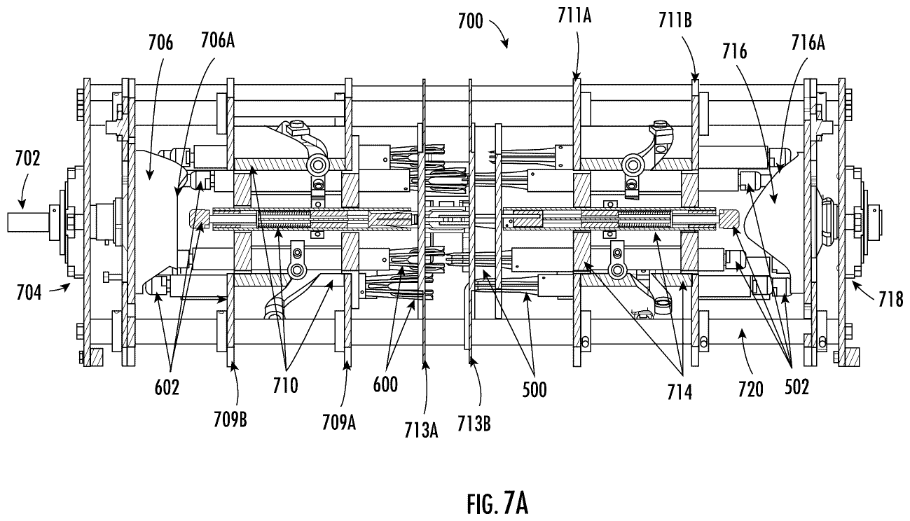

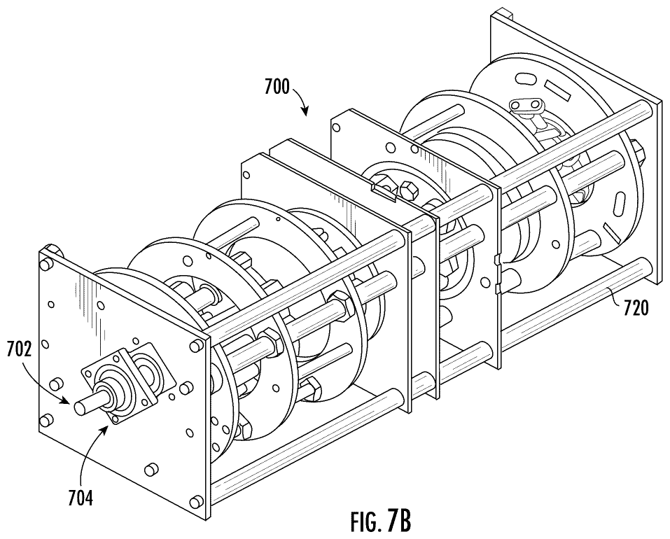

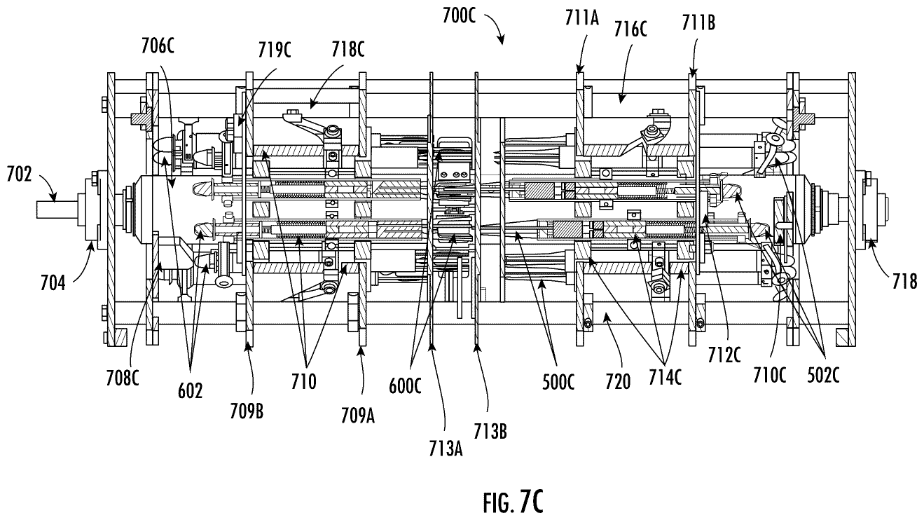

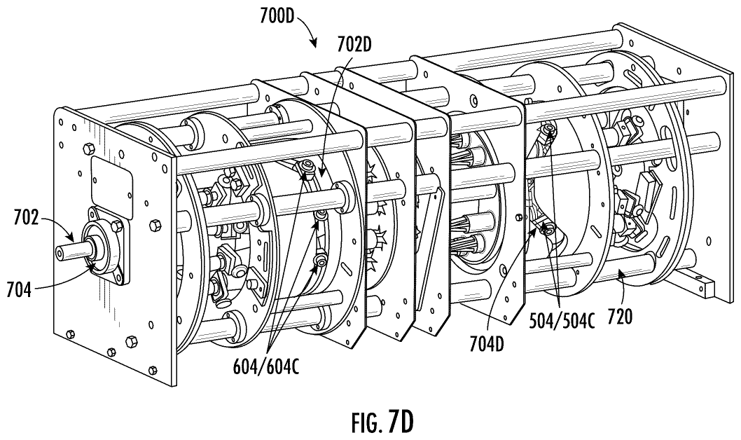

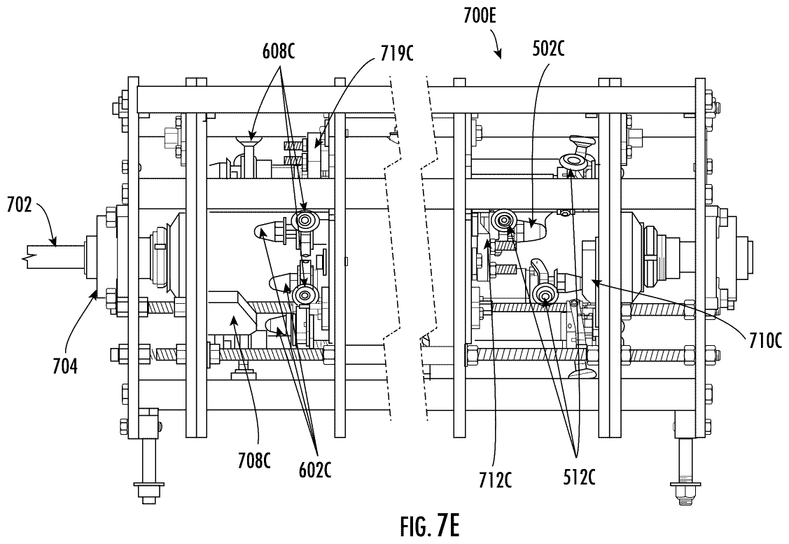

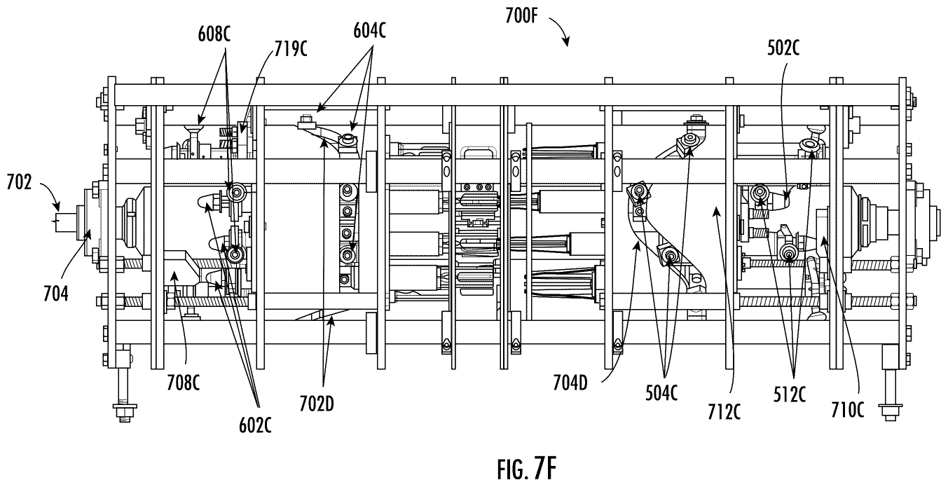

FIG. 5C shows a side view of another example plucker assembly that is shown in FIG. 5B and may be used in an apparatus for pitting fruits, according to some embodiments. In these embodiments, the plucker assembly 500C includes a plucker jaw 506C which is actuated to open and close by a plunger 502C which may be made of some hard materials in some embodiments (e.g., metals, alloys, harder polymeric materials, and others) or shock-absorbing, soft materials (e.g., softer polymeric materials such as a rubber compound, and others) The plucker assembly 500C may be further fixedly or removably attached to a cam block 504C which controls or restrains (e.g., via engagement with a guide track or slot such as 702D or 704D in FIG. 7D) the advancement and retraction of the plucker assembly 500C. A cam includes a rotating or sliding mechanism, or combination, that translates motion in one direction into motion in a different direction in some embodiments. For example, a cam may include a rotating or sliding component in a mechanical linkage used especially in transforming rotary motion into linear motion.

The plucker jaw 506C is devised to grab one end of a pit when the plucker assembly 500C advances with its plucker jaw 506C open to engage with the calyx end of a fruit, and the plucker jaw 506C closes when the plucker assembly 500C is at the designated stop position. The advancement and retraction of the plucker assembly 500C may be guided by a cam block 504C which is in turn actuated upon by a cam. The open and close actions of the plucker assembly 500C may be controlled or caused by the plunger 502C.

In some embodiments, the interaction of a cam with a latching wheel 512C while the plunger 502C together with the components attached thereto is pushed in the direction towards the plucker jaw 506C (and hence compress the spring 508D in FIG. 5D) and open up the latch 508C until the latching wheel 512C is disengaged with a cam or a first surface of a cam where the latch 508C is then engaged with the washer 510C to lock maintain the plucker jaw 506C in an open position so that the plucker jaw 506C is ready to, for example, release a pit of a fruit. When the latching wheel 512C is engaged with a separate cam or a second surface of the same cam different from the first surface, the engagement causes the latch 508C to disengage from the washer 510C so that the spring (e.g., 508D in FIG. 5D) returns the plunger together with the components attached thereto to their natural position so as to return the plucker jaw 506C to its closed position (e.g., to grab onto a pit of a fruit) although the presence of the pit held by the plucker jaw 506C may prevent the plucker jaw 506C from returning to the fully closed position.

FIG. 5D shows a cross-sectional view of the example plucker assembly shown in FIG. 5C, according to some embodiments. More specifically, the plucker assembly (e.g., reference numeral 500C in FIG. 5C) includes an open-close plunger 502C which is operatively coupled with a return spring 508D that is further operatively coupled with a guide rod 512D on one end so that the open-close plunger 502C, when actuated, pushes the guide rod 512D with the spring force of the return spring 508D and returns the guide rod 512D to its neutral or closed position when the spring force of the return spring 508D is released.

Another end of the guide rod 512D is operatively coupled with (e.g., fixedly or removably attached) to a plucker jaw actuator 510D. The plucker jaw actuator 510D includes a corresponding geometric feature (e.g., a curved or slanted surface) that respectively mates with a jaw finger 506D of the jaw so that with the advancement and retraction of the plucker jaw actuator 510D, the corresponding geometric feature causes the plucker jaw finger 506C to open and close. A jaw finger 506C1 of the plucker jaw 506C may include one or more teeth 506D on the free-tip end (e.g., the end away from the open-close plunger 502C) so that the one or more teeth 506D secure a pit. In some embodiments, a gripper assembly jaw comprises three or more fingers. In one embodiment, a gripper assembly jaw comprises four fingers while in another embodiment, a gripper assembly jaw comprises six fingers. In some embodiments, a plucker assembly jaw comprises three or more fingers. In some embodiments, the figures are in direct contact with fruit and may be made of, for example but not limited to, any FDA (Food and Drug Administration) approved materials such as any food grade material with sufficient properties (e.g., tensile or compressive strength, or combination, manufacturability, wear resistance, and others) or any other required or desired materials.

In some embodiments, the interaction of a cam with a plucker latching wheel 512C while the plunger 502C together with the components attached thereto is pushed in the direction towards the pluckerjaw 506C and hence compress the spring 508D and open up the latch 508C until the plucker latching wheel 512C is disengaged with a cam or a first surface of a cam where the latch 508C is then engaged with the washer 510C to lock maintain the plucker jaw 506C in an open position so that the plucker jaw 506C is ready to, for example, release a pit of a fruit. When the plucker latching wheel 512C is engaged with a separate cam or a second surface of the same cam different from the first surface, the engagement causes the latch 508C to disengage from the washer 510C so that the spring (e.g., 508D in FIG. 5D) returns the plunger together with the components attached thereto to their natural position so as to return the plucker jaw 506C to its closed position (e.g., to grab onto a pit of a fruit with the one or more teeth 506D) although the presence of the pit held by the plucker jaw 506C or the one or more teeth 506D may prevent the plucker jaw 506C from returning to the fully closed position.

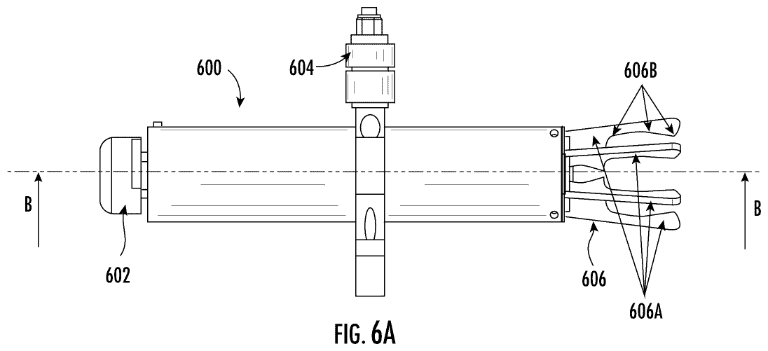

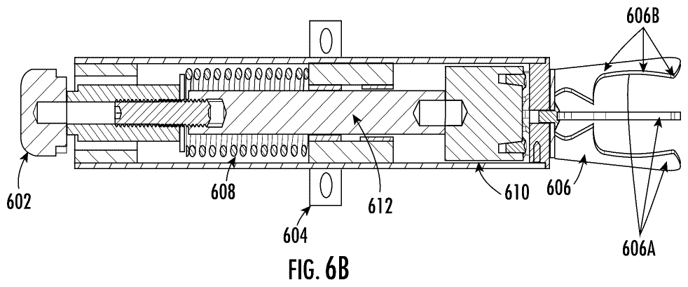

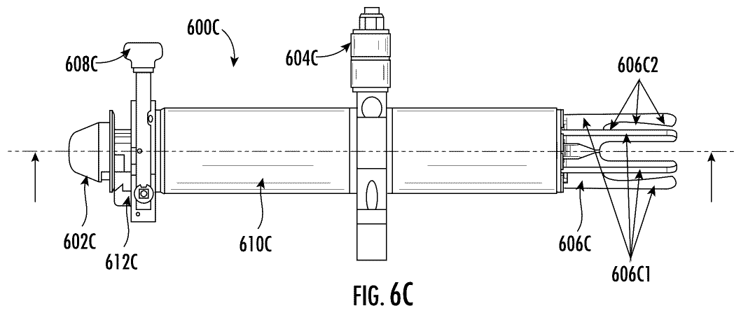

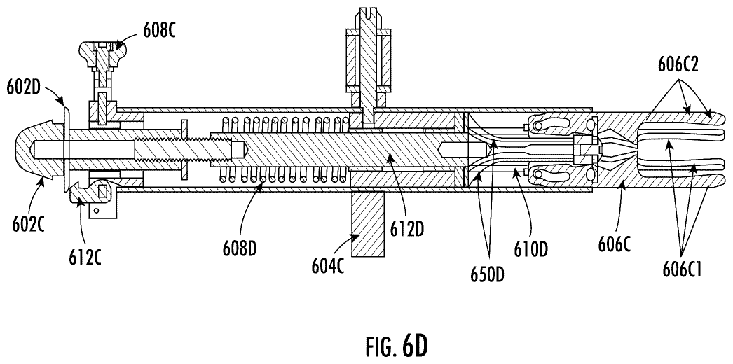

FIG. 6A shows a side view of an example gripper assembly that may be used in an apparatus for pitting fruits, according to some embodiments. In these embodiments, the gripper assembly 600 includes a jaw 606 which is actuated to open and close by a plunger 602. The gripper assembly 600 may be further fixedly or removably attached to a cam block 604 which controls the advancement and retraction of the gripper assembly 600. The jaw 606 includes a plurality of jaw fingers 606A. A jaw finger 606A may have a profile where the free-tip end (e.g., the end away from the open-close plunger 602) may have a wider width than the width of the opposite end of the jaw finger 606A (e.g., the end closer to the open-close plunger 602).

In some of these embodiments, this profile includes rounded edges or smooth transition 606B on a jaw finger 606A so as to prevent the jaw finger 606A from damaging the fruits to be pitted. Another purpose of having the aforementioned unequal widths with a larger width closer to the free-tip end is that when the jaw 606 advances to engage with a fruit, the larger width with rounded edges or smooth transition 606B allows the fruit to be self-centered due to the smaller opening of formed by the jaw fingers at the fully open position as well as due to the rounded edges or smooth transition 606B of the jaw finger 606A.

The jaw 606 is devised to grab the fruit when the gripper assembly 600 advances with its jaw 606 open to engage with the fruit, and the jaw 606 closes when the gripper assembly 600 is at the designated stop position. The advancement and retraction of the gripper assembly 600 may be guided by a cam block 604 which is in turn actuated upon by a cam. The open and close actions of the gripper assembly 600 may be controlled by the plunger 602.

FIG. 6B shows a cross-sectional view of the example gripper assembly shown in FIG. 6A, according to some embodiments. More specifically, the gripper assembly (e.g., reference numeral 600 in FIG. 6A) includes an open-close plunger 602 which is operatively coupled with a return spring 608 that is further operatively coupled with a guide rod 612 on one end so that the open-close plunger 602, when actuated, pushes the guide rod 612 with the spring force of the return spring 608 and returns the guide rod 612 to its neutral or closed position when the spring force of the return spring 608 is released.

Another end of the guide rod 612 is operatively coupled with (e.g., fixedly or removably attached) to a gripper jaw actuator 610. The gripper jaw actuator 610 includes a corresponding geometric feature 606B that respectively mates with a jaw finger 606A of the jaw 606 so that with the advancement and retraction of the gripper jaw actuator 610 through the open-close plunger 602, the corresponding geometric feature causes the jaw finger 606A to open and close.

FIG. 6C shows a side view of another example gripper assembly that may be used in an apparatus for pitting fruits, according to some embodiments. In these embodiments, the gripper assembly 600C includes a jaw 606C which is actuated to open or close (or partially close) by a gripper assembly plunger 602C. The gripper assembly 600C may be further fixedly or removably attached to a cam block 604C which controls the advancement and retraction of the gripper assembly 600C. The jaw 606C includes a plurality of jaw fingers 606C1. A jaw finger 606C1 may have a profile 606C2 where the free-tip end (e.g., the end away from the gripper assembly plunger 602C) may have a wider width than the width of the opposite end of the jaw finger 606C1 (e.g., the end closer to the gripper assembly plunger 602C).

In some of these embodiments, this profile includes rounded edges or smooth transition 606C2 on a jaw finger 606C1 so as to prevent the jaw finger 606C1 from damaging the fruits to be pitted. Another purpose of having the aforementioned unequal widths with a larger width closer to the free-tip end is that when the jaw 606C advances to engage with a fruit, the larger width with rounded edges or smooth transition 606C2 allows the fruit to be self-centered due to the smaller opening of formed by the jaw fingers at the fully open position as well as due to the rounded edges or smooth transition of the profile 606C2 of the jaw finger 606C1.

The jaw 606C is devised to grab the fruit when the gripper assembly 600C advances with its jaw 606C open to engage with the fruit, and the jaw 606C closes when the gripper assembly 600C is at the designated stop position. The advancement and retraction of the gripper assembly 600C may be guided by a cam block 604C which is in turn actuated upon by a cam. The open and close actions of the gripper assembly 600C may be controlled by the gripper assembly plunger 602C.

FIG. 6D shows a cross-sectional view of the example gripper assembly shown in FIG. 6C, according to some embodiments. More specifically, the gripper assembly (e.g., reference numeral 600C in FIG. 6C) includes a gripper assembly plunger 602C which is operatively coupled with a return spring 608D that is further operatively coupled with a guide rod 612D on one end so that the gripper assembly plunger 602C, when actuated, pushes the guide rod 612D with the spring force of the return spring 608D and returns the guide rod 612D to its neutral or closed position when the spring force of the return spring 608D is released.

Another end of the guide rod 612D is operatively coupled with (e.g., fixedly or removably attached) to a gripper jaw actuator 610D. The gripper jaw actuator 610D includes a corresponding geometric feature 650D (e.g., a curved or slanted surface) that respectively mates with a jaw finger 606C1 of the jaw 606C so that with the advancement and retraction of the gripper jaw actuator 610D through the gripper assembly plunger 602C, the corresponding geometric feature causes the jaw finger 606C1 to open and close.

FIG. 6D further shows a cross-section view of the latching wheel 608C, the latch 612C, and the washer 602D. In some embodiments, the interaction of a cam with the latching wheel 608C while the gripper assembly plunger 602C together with the components attached thereto is pushed in the direction towards the jaw 606C and hence compress the spring 608D and open up the latch 612C until the latching wheel 608C is disengaged with a cam or a first surface of a cam where the latch 612C is then engaged with the washer 602D to lock maintain the jaw 606C in an open position so that the jaw 606C is ready to, for example, receive a fruit. When the latching wheel 608C is engaged with a separate cam or a second surface of the same cam different from the first surface, the engagement causes the latch 612C to disengage from the washer 602D so that the spring 608D returns the gripper assembly plunger 602C together with the components attached thereto (e.g., the guide rod 612D) to their natural position so as to return the jaw 606C to its closed position (e.g., to grab onto a fruit with the jaw fingers 606C1) although the presence of the fruit held by the jaw 606C may prevent the jaw 606C from returning to the fully closed position.

FIG. 7A shows a cross-sectional view of the example pitting head assembly shown in FIG. 1A, according to some embodiments. More specifically, this section view shows that the example pitting head assembly 700 includes a plurality of plucker assemblies 500 and a plurality of gripper assemblies 600. In some embodiments, each plucker assembly 500 corresponds to a respective gripper assembly 600 where the plucker assembly 500 and the gripper assembly 600 in a pair are substantially aligned with one another (e.g., substantially aligned in the sense that the plucker assembly 500 and the gripper assembly 600 are designed to be aligned along their respective center lines while allowing a small deviation resulting from, for example, one or more tolerances such as a manufacturing tolerance, a slack between mating components as designed, or normal wear and tear, or a combination). The plurality of the plucker assemblies 500 and the plurality of gripper assemblies 600 may be respectively arranged in a pattern. In some embodiments, the plurality of the plucker assemblies 500 may be uniformly or non-uniformly arranged in a circular pattern, and the plurality of gripper assemblies 600 is also uniformly or non-uniformly arranged in the same circular pattern.

In some embodiments, a gripper assembly 600 may be mounted through respective bushings or bearings on a first gripper base plate 709A and a second gripper base plate 709B where a first respective bushing or bearing is mounted to the first gripper base plate 709A, and the second respective bushing or bearing is mounted to the second gripper base plate 709B. The first and second respective bushings or bearings are to allow a gripper assembly 600 to move smoothly along the axial direction of the gripper assembly 600 via the gripper actuator cam 706.

In some embodiments, a plucker assembly 500 may be mounted through respective bushings or bearings on a first plucker base plate 711A and a second plucker base plate 711B where a first respective bushing or bearing is mounted to the first plucker base plate 711A, and the second respective bushing or bearing is mounted to the second plucker base plate 711B. The first and second respective bushings or bearings are to allow a plucker assembly 500 to move smoothly along the axial direction of the plucker assembly 500.

The pit removal may be accomplished by actuating the plurality of gripper assemblies 600 and the plurality of plucker assemblies 500. In some embodiments, pit removal may occur within the two walls 713A and 713B having respective apertures to clear the moving components of the gripper assemblies 600 and the plucker assemblies 500. In some embodiments, the wall 713B may serve as a physical stop for the fruits to be pitted while each of the plurality of gripper assemblies 600 extends along the direction from the wall 713A to the wall 713B, self-centers the fruit with respect to the jaw of the gripper assembly 600, secures the fruit with the jaw fingers, and stops at or before the wall 713B.

The two walls 713A and 713B may also define the space (collectively pit removal space) where a conveyor belt (not shown in FIG. 7A) carries fruits for the plurality of plucker assemblies 500 and the plurality of gripper assemblies 600 to act upon for pit removal.

A plucker assembly 500 may be acted upon by the plucker actuator cam 716 that has a profile surface 716A to actuate the plurality of plucker assemblies 500. In some embodiments, each of the plurality of plucker assemblies 500 is a passive device and moves only by ways of the rotatory motion of the plucker actuator cam 716 having the profile surface 716A.

For example, a high point on the profile surface, when hitting an open-close plunger 502 of a plucker assembly 500, pushes the plucker assembly 500 in direct contact with the high point towards the pit removal space while the contact between the open-close plunger 502 of this plucker assembly 500 and the high point on the profile surface 716A pushes the open-close plunger 502 and compresses the return spring in the plucker assembly 500 to open the jaw fingers of the plucker assembly 500. As the contact between the open-close plunger 502 and the profile surface 716A moves farther away from the high point. The open-close plunger 502 closes, and the compressed return spring of the plucker assembly 500 forces the plucker jaw to close and hinge onto, for example, the calyx end of the pit of a fruit. The cam action may cause the plucker assembly 500 hinging onto the pit to retract from the pit removal space back to its neutral or closed position in some embodiments.

Similarly, a gripper assembly 600 may be acted upon by the gripper actuator cam 706 that has a profile surface 706A to actuate the plurality of gripper assemblies 600. In some embodiments, each of the plurality of gripper assemblies 600 is a passive device and moves only by ways of the rotatory motion of the gripper actuator cam 706 having the profile surface 706A. The advancement and retraction movement of a plucker assembly 500 may be guided by using, for example, its cam block (e.g., reference numeral 504 in FIG. 5A).

For example, a high point on the profile surface 706A, when hitting an open-close plunger 602 of a gripper assembly 600, pushes the gripper assembly 600 in direct contact with the high point towards the pit removal space while the contact between the open-close plunger 602 of this gripper assembly 600 and the high point on the profile surface 706A pushes the open-close plunger 602 and compresses the return spring in the gripper assembly 600 to open the jaw fingers of the gripper assembly 600. As the contact between the open-close plunger 602 and the profile surface 706A moves farther away from the high point. The open-close plunger 602 closes, and the compressed return spring of the gripper assembly 600 forces the gripper jaw to close and secure a fruit with its closed jaw fingers. The cam action may cause the gripper assembly 600 holding to retract from the pit removal space in some embodiments. Either within or outside the pit removal space, the profile space 706A may be devised in such a way to engage with the open-close plunger 602 so that the compressed return spring may release its energy and causes the gripper jaw to open its fingers to release the pitted fruit.

The plurality of cam blocks respectively corresponding to the plurality of plucker assemblies 500 may be guided using a plucker actuator assembly 714 which may include a specific guide path that guides the plurality of cam blocks (e.g., 504 in FIG. 5A) of the plurality of plucker assemblies 500. Similarly, the plurality of cam blocks (e.g., 604 of FIG. 6A) respectively corresponding to the plurality of gripper assemblies 600 may also be guided using a gripper actuator assembly 710 which may include a specific guide path that guides the plurality of cam blocks of the plurality of gripper assemblies 600. In some of the embodiments shown in FIG. 7A, the plurality of gripper assemblies 600 and the plurality of plucker assemblies 500 are not actively powered or directly driven to exhibit movements or motion but are passively, respectively driven by the gripper actuator cam 706 and the plucker actuator cam 716 as well as the return springs in the gripper and plucker assemblies.

The pitting head assembly 700 may include a frame for attaching various components described herein. The motions of the actuator cams (e.g., 706 and 716) may be driven by the drive shaft 702 which may be operatively coupled with a device or a drive that converts an electrical energy input into a mechanical energy output (e.g., an electric motor) and may be mounted to the frame 720 using at least a respective bearings 704 and 718 as well as other suitable mounting means such as fasteners.

FIG. 7B shows an isometric view of the example pitting head assembly shown in FIG. 7A, according to some embodiments. More specifically, FIG. 7B shows the relationships between the drive shaft 702, the bushing or bearing 704, and the frame 720 of the example pitting head assembly 700 of FIG. 7A.

FIG. 7C shows a cross-sectional view of the example pitting head assembly shown in FIG. 1B, according to some embodiments. It shall be noted that some of the reference numerals in FIGS. 7C-7D may be identical to those in FIGS. 7A-7B because these reference numerals correspond to components that may be shared in the two different example pitting head assemblies shown in FIGS. 1A and 1B. Nonetheless, the use of the same reference numerals may or may not necessarily mean that these corresponding components are necessarily identical. Rather, some slight changes may exist between the same reference numeral in, for example, FIGS. 7A and 7C (or FIGS. 7B and 7D) to accommodate the changes in the pitting head assemblies (or the changes in the transition devices, or a combination) as these slight changes in the same reference numeral are not germane to the novelty of the present disclosure. More specifically, this section view shows that the example pitting head assembly 700C includes a plurality of plucker assemblies 500C and a plurality of gripper assemblies 600C. In some embodiments, each plucker assembly 500C corresponds to a respective gripper assembly 600C where the plucker assembly 500C and the gripper assembly 600C in a pair are substantially aligned with one another (e.g., substantially aligned in the sense that the plucker assembly 500C and the gripper assembly 600C are designed to be aligned along their respective center lines or respective axles while allowing a small deviation resulting from, for example, one or more tolerances such as a manufacturing tolerance, a slack between mating components as designed, or normal wear and tear, or a combination). The plurality of the plucker assemblies 500C and the plurality of gripper assemblies 600C may be respectively arranged in a pattern. In some embodiments, the plurality of the plucker assemblies 500C may be uniformly or non-uniformly arranged in a circular pattern, and the plurality of gripper assemblies 600 is also uniformly or non-uniformly arranged in the same circular pattern.

In some embodiments, a gripper assembly 600C may be mounted through respective bushings or bearings on a first gripper base plate 709A and a second gripper base plate 709B where a first respective bushing or bearing is mounted to the first gripper base plate 709A, and the second respective bushing or bearing is mounted to the second gripper base plate 709B. The first and second respective bushings or bearings are to allow a gripper assembly 600C to move smoothly along the axial direction of the gripper assembly 600C via the gripper actuator cam 706.

A cam includes a rotating or sliding component or mechanism that is designed to impart a specific motion to a different component or mechanism through direct contact by converting rotational or translational motion to a different motion of the different component or mechanism. In some embodiments, a pitting head assembly 700C includes a plurality of cams. For example, the pitting head assembly 700C rotates the plurality of gripper assemblies 600C around the drive shaft 702 where the guide track or slot 702D causes each gripper assembly 600C the plurality of gripper assemblies 600C to also exhibit linear, back and forth motions along the axis of the guide rod 612D (e.g., by guiding the cam block 604C of a gripper assembly 600C with the guide track or slot 702D). This linear motion facilitates the gripper assembly latching wheel 608C of a gripper assembly 600C to engage a gripper latch trigger cam 719C to cause the gripper latch 612C to an open position (612C in FIG. 6D shows the gripper latch 612C in the closed position) that enables the plurality of gripper assembly jaw fingers 606C1 of the gripper assembly jaw 606C to open (e.g., by using, for example, a profile surface of the gripper latch trigger cam 719C) to an open position to receive a fruit.

A moment later (e.g., when the gripper assembly 600C is ready to release a pitted fruit), a gripper latching cam 708C acts on the gripper assembly plunger 602C to cause the gripper latch 612C to an open position to disengage the washer 602D. The spring force of the spring 608D returns the guide rod 612D and the gripper assembly jaw 606C to retract along the direction towards the gripper assembly plunger 602C where the geometric features 650D cause the plurality of gripper assembly jaw fingers 606C1 to close (e.g., to hold onto the fruit with the plurality of gripper assembly fingers 606C1 or to close the plurality of gripper assembly fingers 606C1 after releasing the pitted fruit).

In some embodiments, the pitting head assembly 700C rotates the plurality of plucker assemblies 500C around the drive shaft 702 where the guide track or slot 704D causes each plucker assembly 500C the plurality of plucker assemblies 500C to also exhibit linear, back and forth motions along the axis of the guide rod 512D (e.g., by guiding the cam block 504C of a plucker assembly 500C with the guide track or slot 704D). This linear motion facilitates the plucker latching wheel 512C of a plucker assembly 500C to engage a plucker latch trigger cam 712C to cause the plucker latch 508C to an open position (508C in FIG. 5C shows the plucker latch 508C in an open position) that enables the plurality of plucker assembly jaw fingers 506C1 of the plucker assembly jaw 506C to open (e.g., by using, for example, a profile surface of the plucker latch trigger cam 712C) to an open position to receive a fruit.

A moment later (e.g., when the plucker assembly 500C is ready to release a pit of a fruit), a plucker latching cam 710C acts on the plucker assembly plunger 502C to cause the plucker latch 508C to an open position to disengage the washer 510C. The spring force of the spring 508D returns the guide rod 512D and the plucker assembly jaw 506C to retract along the direction towards the plucker assembly plunger 502C where the geometric features 510D cause the plurality of plucker assembly jaw fingers 506C1 to close (e.g., to hold onto the pit of the fruit with the teeth 506D of the plurality of plucker assembly fingers 506C1 or to close the plurality of plucker assembly fingers 506C1 after releasing the pit of the fruit).

In some embodiments, a plucker assembly 500C may be mounted through respective bushings or bearings on a first plucker base plate 711A and a second plucker base plate 711B where a first respective bushing or bearing is mounted to the first plucker base plate 711A, and the second respective bushing or bearing is mounted to the second plucker base plate 711B. The first and second respective bushings or bearings are to allow a plucker assembly 500C to move smoothly along the axial direction of the plucker assembly 500C.

The pit removal may be accomplished by actuating the plurality of gripper assemblies 600C and the plurality of plucker assemblies 500C. In some embodiments, pit removal may occur within the two walls 713A and 713B having respective apertures to clear the moving components of the gripper assemblies 600C and the plucker assemblies 500C. In some embodiments, the wall 713B may serve as a physical stop for the fruits to be pitted while each of the plurality of gripper assemblies 600C extends along the direction from the wall 713A to the wall 713B, self-centers the fruit with respect to the jaw 606C of the gripper assembly 600C, secures the fruit with the jaw fingers, and stops at or before the wall 713B.

The two walls 713A and 713B may also define the space (collectively pit removal space) where a conveyor belt (not shown in FIG. 7C) carries fruits for the plurality of plucker assemblies 500C and the plurality of gripper assemblies 600C to act upon for pit removal. In some embodiments, each of the plurality of plucker assemblies 500C is a passive device and moves only by ways of the rotatory motion of the aforementioned plucker actuator cam 716C. In some embodiments, each of the plurality of gripper assemblies 600C is a passive device and moves only by ways of the rotatory motion of the aforementioned gripper actuator cam 718C.

For example, a high point on the profile surface, when hitting an open-close plunger 502C of a plucker assembly 500C, pushes the plucker assembly 500C in direct contact with the high point towards the pit removal space while the contact between the open-close plunger 502C of this plucker assembly 500C and the high point on the profile surface (e.g., 716A in FIG. 7A yet covered in FIG. 7C) pushes the open-close plunger 502C and compresses the return spring in the plucker assembly 500C to open the jaw fingers of the plucker assembly 500C. As the contact between the open-close plunger 502C and the profile surface (e.g., 716A in FIG. 7A yet covered in FIG. 7C) moves farther away from the high point. The open-close plunger 502C closes, and the compressed return spring of the plucker assembly 500C forces the plucker jaw to close and hinge onto, for example, the calyx end of the pit of a fruit. The cam action may cause the plucker assembly 500C hinging onto the pit to retract from the pit removal space back to its neutral or closed position in some embodiments.

Similarly, a gripper assembly 600C may be acted upon by the gripper actuator cam 718C that has a profile surface (e.g., 706A in FIG. 7A yet covered in FIG. 7C) to actuate the plurality of gripper assemblies 600C. In some embodiments, each of the plurality of gripper assemblies 600C is a passive device and moves only by ways of the rotatory motion of the gripper actuator cam 718C having the profile surface (e.g., 706A in FIG. 7A yet covered in FIG. 7C). The advancement and retraction movement of a plucker assembly 500C may be guided by using, for example, its cam block (e.g., reference numeral 504 in FIG. 5A or 504C in FIG. 7D) constrained by a guide or track (e.g., 704D in FIG. 7D).

For example, a high point on the profile surface (e.g., 706A in FIG. 7A yet covered in FIG. 7C), when hitting an open-close plunger 602C of a gripper assembly 600C, pushes the gripper assembly 600C in direct contact with the high point towards the pit removal space while the contact between the open-close plunger 602C of this gripper assembly 600C and the high point on the profile surface (e.g., 706A in FIG. 7A yet covered in FIG. 7C) pushes the open-close plunger 602C and compresses the return spring in the gripper assembly 600C to open the jaw fingers of the gripper assembly 600C. As the contact between the open-close plunger 602C and the profile surface (e.g., 706A in FIG. 7A yet covered in FIG. 7C) moves farther away from the high point. The open-close plunger 602C closes, and the compressed return spring (e.g., 608D) of the gripper assembly 600C forces the gripper jaw 606C to close and secure a fruit with its closed jaw fingers 606C1. The cam action may cause the gripper assembly 600C holding to retract from the pit removal space in some embodiments. Either within or outside the pit removal space, the profile space (e.g., 706A in FIG. 7A yet covered in FIG. 7C) may be devised in such a way to engage with the open-close plunger 602C so that the compressed return spring may release its energy and causes the gripper jaw to open its fingers to release the pitted fruit.

The plurality of cam blocks respectively corresponding to the plurality of plucker assemblies 500C may be guided using a plucker actuator cam 716C which may include a specific guide path that guides the plurality of cam blocks (e.g., 504 in FIG. 5A or 504C in FIG. 7D) of the plurality of plucker assemblies 500C. Similarly, the plurality of cam blocks (e.g., 604 of FIG. 6A or 604C of FIG. 6C) respectively corresponding to the plurality of gripper assemblies 600C may also be guided using a gripper actuator assembly 718C which may include a specific guide path that guides the plurality of cam blocks of the plurality of gripper assemblies 600C. In some of the embodiments shown in FIG. 7C, the plurality of gripper assemblies 600C and the plurality of plucker assemblies 500C are not actively powered or directly driven to exhibit movements or motion but are passively, respectively driven by the gripper actuator cam 718C and the plucker actuator cam 716C as well as the return springs (e.g., 508D and 608D) in the gripper and plucker assemblies.

The pitting head assembly 700C may include a frame for attaching various components described herein. The motions of the actuator cams (e.g., the gripper actuator cam 718C and the plucker actuator cam 716C) may be driven by the drive shaft 702 which may be operatively coupled with a device or a drive that converts an electrical energy input into a mechanical energy output (e.g., an electric motor) and may be mounted to the frame 720 using at least a respective bearings 704 and 718 as well as other suitable mounting means such as fasteners.

FIG. 7D shows an isometric view of the example pitting head assembly shown in FIG. 7C, according to some embodiments. More specifically, FIG. 7B shows the relationships between the drive shaft 702, the bushing or bearing 704, and the frame 720 of the example pitting head assembly 700 of FIG. 7A.

FIG. 7D further shows guiding or restraining the motion or trajectory of the plurality of cam blocks (e.g., 504 in FIG. 5A or 504C in FIG. 7D), or a combination, of the plurality of plucker assemblies 500C with the guide or track 704D. FIG. 7D further shows guiding or restraining the motion or trajectory of the plurality of cam blocks (e.g., 604 in FIG. 6A or 604C in FIG. 7D), or a combination, of the plurality of gripper assemblies 600C with the guide or track 702D.

FIG. 7E shows a side view of the example pitting head assembly shown in FIG. 1B at a time instant, according to some embodiments. In these embodiments, the pitting head assembly 700E includes a drive shaft 702 that is attached via a busing or bearing 704 to a frame to which a plurality gripper assemblies 600C and a plurality of plucker assemblies 500C are attached.

In some of these embodiments, the pitting head assembly 700E includes the plurality of plucker assemblies (e.g., 500C) each of which includes a plucker assembly plunger 502C and a plucker assembly latching wheel 512C of a plucker assembly 500C. The plucker assembly latching wheel 512C of a plucker assembly 500C engages a plucker latch trigger cam 712C to cause the plucker assembly latch 508C to an open position (e.g., 508C in FIG. 5C shows the plucker latch 508C in an open position) that enables and facilitates the plurality of plucker assembly jaw fingers 506C1 of the plucker assembly jaw 506C to open (e.g., by using, for example, a profile surface of the plucker latch trigger cam 712C) to an open position to receive a fruit.

FIG. 7E further shows that the pitting head assembly 700E includes a plucker assembly latching cam 710C and its relative position to a plucker assembly plunger 502C. In some embodiments, a plucker assembly latching cam 710C acts on a plucker assembly plunger 502C to cause the plucker latch (e.g., 508C) to an open position to disengage the washer (e.g., 510C). The spring force of the spring (e.g., 508D) returns the guide rod (e.g., 512D) and the plucker assembly jaw (e.g., 506C) to retract along the direction towards the plucker assembly plunger 502C where the geometric features (e.g., 510D) cause the plurality of plucker assembly jaw fingers (e.g., 506C1) to close.

In some of these embodiments, the pitting head assembly 700E further includes a plurality of gripper assemblies (e.g., 600C) each having a gripper assembly plunger 602C and a gripper assembly latching wheel 608C of a gripper assembly (e.g., 600C). The gripper assembly latching wheel 608C engages a gripper latch trigger cam 719C to cause the gripper assembly latch (e.g., 612C) to an open position that enables and facilitates the plurality of gripper assembly jaw fingers (e.g., 606C1) of the gripper assembly jaw (e.g., 606C) to open (e.g., by using, for example, a profile surface of the gripper latch trigger cam 719C) to an open position to receive a fruit.

FIG. 7E shows a gripper latching cam 708C and its relative position to the gripper assembly plunger 602C. In some embodiments, the gripper assembly latching cam 708C acts on a gripper assembly plunger 602C to cause the gripper latch (e.g., 612C) to an open position to disengage the washer (e.g., 602D). The spring force of the spring (e.g., 608D) returns the guide rod (e.g., 612D) and the gripper assembly jaw (e.g., 606C) to retract along the direction towards the gripper assembly plunger 602C where the geometric features (e.g., 650D) cause the plurality of gripper assembly jaw fingers (e.g., 606C1) to close.

In some of these embodiments, the pitting head assembly 700E includes the plurality of gripper assemblies (e.g., 600C) each of which includes a gripper assembly plunger 602C and a gripper assembly latching wheel 608C of a gripper assembly 600C to engage a gripper latch trigger cam 719C to cause the gripper latch 612C to an open position that enables the plurality of gripper assembly jaw fingers (e.g., 606C1) of the gripper assembly jaw 606C to open (e.g., by using, for example, a profile surface of the gripper latch trigger cam 719C) to an open position to receive a fruit.

FIG. 7E further shows a plucker latching cam 710C and its relative position to a plucker assembly latching wheels 512C at the instant shown in FIG. 7E. In some embodiments, the plucker latching cam 710C acts on the plucker assembly plunger 502C to cause the plucker latch 508C to an open position to disengage the washer 510C. The spring force of the spring 508D returns the guide rod 512D and the plucker assembly jaw 506C to retract along the direction towards the plucker assembly plunger 502C where the geometric features 510D cause the plurality of plucker assembly jaw fingers 506C1 to close.

In some embodiments, a plucker latching wheel 512C of a plucker assembly 500C in the pitting head assembly 700E engages a plucker latch trigger cam 712C to cause the plucker latch 508C to an open position (e.g., 508C in FIG. 5C shows the plucker latch 508C in an open position) that enables the plurality of plucker assembly jaw fingers (e.g., 506C1) of the plucker assembly jaw (e.g., 506C) to open (e.g., by using, for example, a profile surface of the plucker latch trigger cam 712C) to an open position to receive a fruit.

FIG. 7F shows a side view of the example pitting head assembly shown in FIG. 7C, according to some embodiments. In these embodiments, the pitting head assembly 700E includes a drive shaft 702 that is attached via a busing or bearing 704 to a frame to which a plurality gripper assemblies (e.g., 600C) and a plurality of plucker assemblies (e.g., 500C) are attached.

In some of these embodiments, the pitting head assembly 700E includes the plurality of plucker assemblies (e.g., 500C) each of which includes a plucker assembly plunger 502C and a plucker assembly latching wheel 512C of a plucker assembly 500C. The plucker assembly latching wheel 512C of a plucker assembly 500C engages a plucker latch trigger cam 712C to cause the plucker assembly latch 508C to an open position that enables and facilitates the plurality of plucker assembly jaw fingers (e.g., 506C1) of the plucker assembly jaw (e.g., 506C) to open in order to an open position to receive a fruit.

FIG. 7F further shows that the pitting head assembly 700F includes a plucker assembly latching cam 710C and its relative position to a plucker assembly plunger 502C. In some embodiments, a plucker assembly latching cam 710C acts on a plucker assembly plunger 502C to cause the plucker latch (e.g., 508C) to an open position to disengage the washer (e.g., 510C). The spring force of the spring (e.g., 508D) returns the guide rod (e.g., 512D) and the plucker assembly jaw (e.g., 506C) to retract along the direction towards the plucker assembly plunger 502C where the geometric features (e.g., 510D) cause the plurality of plucker assembly jaw fingers (e.g., 506C1) to close.

In some of these embodiments, the pitting head assembly 700F further includes a plurality of gripper assemblies (e.g., 600C) each having a gripper assembly plunger 602C and a gripper assembly latching wheel 608C of a gripper assembly (e.g., 600C). The gripper assembly latching wheel 608C engages a gripper latch trigger cam 719C to cause the gripper assembly latch (e.g., 612C) to an open position that enables and facilitates the plurality of gripper assembly jaw fingers (e.g., 606C1) of the gripper assembly jaw (e.g., 606C) to open (e.g., by using, for example, a profile surface of the gripper latch trigger cam 719C) to an open position to receive a fruit.

FIG. 7F shows a gripper latching cam 708C and its relative position to the gripper assembly plunger 602C. In some embodiments, the gripper assembly latching cam 708C acts on a gripper assembly plunger 602C to cause the gripper latch (e.g., 612C) to an open position to disengage the washer (e.g., 602D). The spring force of the spring (e.g., 608D) returns the guide rod (e.g., 612D) and the gripper assembly jaw (e.g., 606C) to retract along the direction towards the gripper assembly plunger 602C where the geometric features (e.g., 650D) cause the plurality of gripper assembly jaw fingers (e.g., 606C1) to close.

In some of these embodiments, the pitting head assembly 700F includes the plurality of gripper assemblies (e.g., 600C) each of which includes a gripper assembly plunger 602C and a gripper assembly latching wheel 608C of a gripper assembly 600C to engage a gripper latch trigger cam 719C to cause the gripper latch 612C to an open position that enables the plurality of gripper assembly jaw fingers (e.g., 606C1) of the gripper assembly jaw 606C to open (e.g., by using, for example, a profile surface of the gripper latch trigger cam 719C) to an open position to receive a fruit.

FIG. 7F further shows a plucker latching cam 710C and its relative position to a plucker assembly latching wheels 512C at the instant shown in FIG. 7F. In some embodiments, the plucker latching cam 710C acts on the plucker assembly plunger 502C to cause the plucker latch 508C to an open position to disengage the washer 510C. The spring force of the spring 508D returns the guide rod 512D and the plucker assembly jaw 506C to retract along the direction towards the plucker assembly plunger 502C where the geometric features 510D cause the plurality of plucker assembly jaw fingers 506C1 to close.

In some embodiments, a plucker latching wheel 512C of a plucker assembly 500C in the pitting head assembly 700F engages a plucker latch trigger cam 712C to cause the plucker latch 508C to an open position (e.g., 508C in FIG. 5C shows the plucker latch 508C in an open position) that enables the plurality of plucker assembly jaw fingers (e.g., 506C1) of the plucker assembly jaw (e.g., 506C) to open (e.g., by using, for example, a profile surface of the plucker latch trigger cam 712C) to an open position to receive a fruit.

FIG. 7F further shows the guide track or slot 704D that constrains the motion of the plurality of plucker assemblies (e.g., 500C) by confining the range of motion of the cam blocks 504C of the plurality of plucker assemblies (e.g., 500C). FIG. 7F also shows the guide track or slot 702D that constrains the motion of the plurality of gripper assemblies (e.g., 600C) by confining the range of motion of the cam blocks 608C of the plurality of plucker assemblies (e.g., 600C).

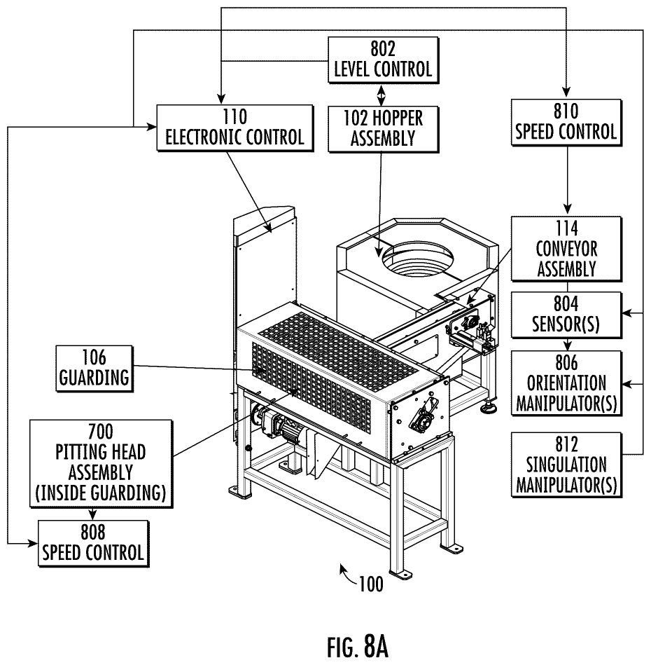

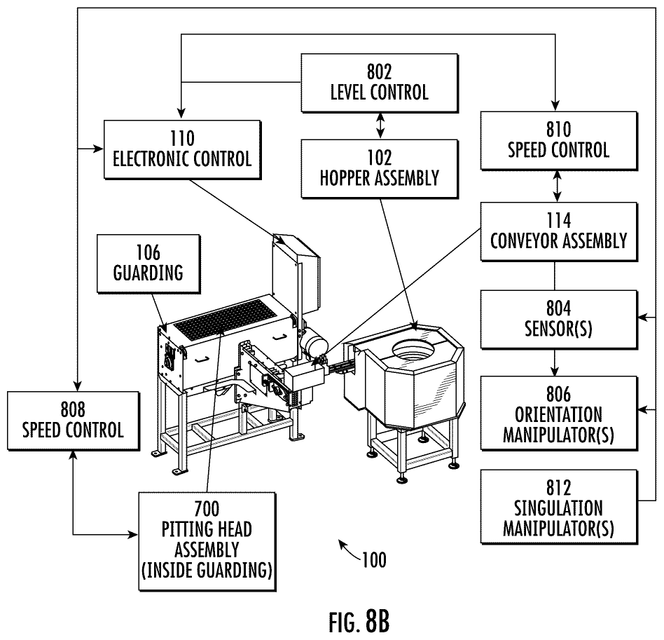

FIG. 8 shows an example block diagram of an apparatus in which some of various techniques described herein for pitting fruits may be implemented, according to some embodiments. In these embodiments, the apparatus for pitting fruits 100 include the pitting heading assembly 700 that is at least partially enclosed in the guarding 106 and receives fruits via a conveyor assembly 114. The conveyor 114 may optionally receive the fruit to be pitted from a loading hopper assembly 102 in some embodiments or from manual loading the fruits into the conveyor assembly 114. The apparatus 100 may also include an electronic control 110 that may be utilized to perform various controls for the apparatus 100.

In some embodiments where the conveyor assembly 114 receives fruits from a loading hopper assembly 102, the electronic control 110 may provide level control 802 for the loading hopper assembly 102. For example, the loading hopper assembly 102 may be equipped with a sensor that monitors the level, amount, or quantity of fruits into the loading hopper assembly. When the level, amount, or quantity of fruits in the loading hopper level drops below a threshold limit, the electronic control 110 may issue a signal or instruction to an upstream supply source (e.g., a separate conveyor feeding the loading hopper assembly 102) for the level control 802.

The electronic control 110 may also provision speed control 808 to the pitting heading assembly 700 and speed control 810 to the conveyor assembly 114 so that the operational speed of the pitting heading assembly 700 and that of the conveyor assembly 114 feeding fruits to the pitting head assembly 700 may be synchronized to avoid, eliminate, or at least reduce undesired wait time or under-utilization of the conveyor assembly 114 or the pitting head assembly 700, or a combination, as well as mismatched operational speeds when one of the two aforementioned assemblies operates at a speed that the other of the two aforementioned assemblies is unable to catch up with.

For example, the conveyor assembly 114 may feed fruits at a speed that the pitting head assembly 700 cannot catch up with and thus leads to fruits that are to be pitted but nevertheless pass through the pitting head assembly 700 without their pits removed. In this example, the electronic control 110 may either increase the operational speed of the pitting head assembly 700, reduce the operational speed of the conveyor assembly 114, or both increase the operational speed of the pitting head assembly 700 and reduce the operational speed of the conveyor assembly 114. In some embodiments, speed control 808 or 810, or both, may be achieved by using a variable frequency drive (VFD). For example, some embodiments may utilize one or more VFDs and one or more potentiators to allow an operator to set a desired speed for the motor and henceforth the drive mechanism that is responsible for the pitting rate of the apparatus 100.

In some embodiments, the conveyor assembly 114 may be operatively coupled with one or more sensors 804 (e.g., an optical sensor, a photo sensor, a computer vision device, and others) that detect whether the fruits in the conveyor assembly 114 (e.g., on a conveyor belt in the conveyor assembly 114) is properly singulated or oriented, or a combination. For example, if it is detected that one or more fruits in the conveyor assembly 114 are not properly singulated, the electronic control 110 may send a signal or instruction to actuate a singulation manipulator to achieve singulation. In some embodiments, each singulated fruit may be checked for its calyx with a sensor (e.g., a photo sensor) or a machine vision device to determine whether the calyx end of the fruit is oriented towards a plucker assembly. For example, if it is detected that a fruit is not properly oriented (e.g., the calyx end of the fruit is facing a gripper assembly, rather than a plucker assembly), the electronic control 110 may send a signal or instruction to actuate an orientation manipulator to mechanically or pneumatically correct the orientation of the fruit or to remove the incorrectly oriented fruit from the conveyor belt and to return it back to the loading hopper 102 or the inlet of the conveyor assembly 114.

In some embodiments, an incorrectly oriented fruit may still be pitted using a pair of gripper assembly and plucker assembly. Nonetheless, the system may issue an instruction to advance the plucker assembly further to ensure that the plucker assembly can still grab an end portion of the pit because the pit is located closer to the calyx end of the fruit. In these embodiments, more epicarp and mesocarp may be removed together with the pit due to the further advancement of the plucker assembly to accommodate the incorrect orientation of the fruit. In some embodiments, fruit orientation may be checked or corrected manually, or a combination. In some embodiments, the loading hopper may help with the orientation or singulation (or a combination) of fruits by, for example, means of the design of the loading hopper and optionally be assisted through a vibrational or a rotation device (or a combination) that allows fruits to be aligned towards the outfeed section of the loading hopper before the loading hopper transports the fruits to the conveyor assembly.

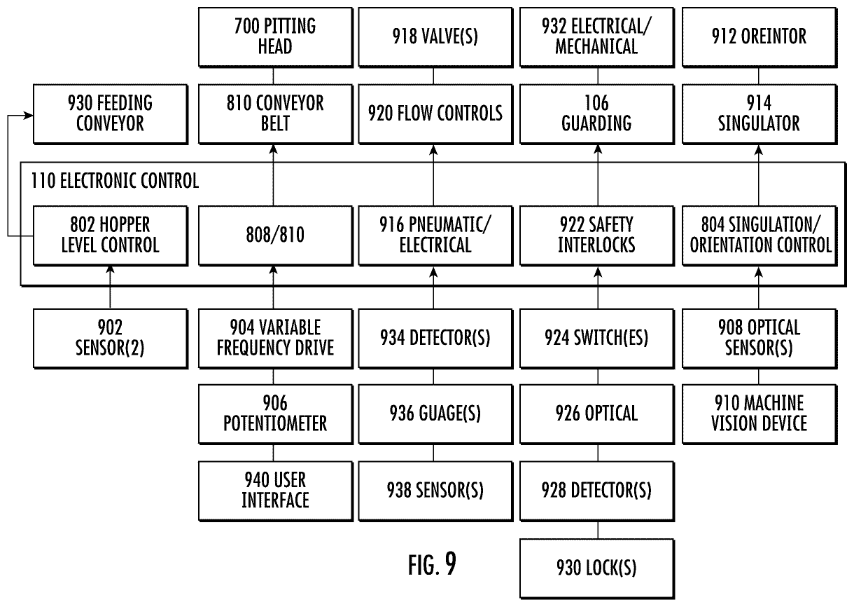

FIG. 9 shows more details about a portion of FIG. 8, according to some embodiments. In these embodiments, the electronic control 110 may include one or more of a loading hopper level control 802, a conveyor belt or pitting head speed control 810, or a combination, a pneumatic or electrical control 916, or a combination, one or more safety interlocks 922, or singulation or orientation control 804, or a combination.

To provision the loading hopper level control 802, the loading hopper may be equipped with one or more sensors 902 that detect, measure, or otherwise determine the level, quantity, or volume of the fruits in the loading hopper. The output of the one or more sensors 902 may be provided to the loading hopper level control 802 which may then issue a signal or an instruction to a feeding conveyor 930 to increase or decrease the transport rate of fruits into the loading hopper when the one or more sensors 902 detect that the level, volume, or quantity of fruits in the loading hopper exceeds a lower threshold limit or an upper threshold limit. In some embodiments, a feeding conveyor 930 may also be used as a lock for the loading hopper.

For example, the loading hopper may be equipped a sensor that measures the level or amount of fruits in the loading hopper where the hopper level control 802 may be triggered to send a signal or instruction to the feeding conveyor 930 to replenish the fruits in the loading hopper when the level or amount drops below a lower threshold limit. As another example, the loading hopper level control 802 may be triggered to send another signal or instruction to stop or decrease the feed rate of fruits from the aforementioned feeding conveyor 930 from replenishing the fruits in the loading hopper to prevent over filling the loading hopper so that the fruits near the bottom of the loading hopper may be subject to larger than desired or required load from the over-filled fruits on top that may cause damage to the fruits at or near the bottom of the loading hopper.

The electronic control 110 may include the conveyor belt speed control 808 or a pitting head speed control 810, or a combination, in some embodiments. In these embodiments, speed control 808 and 810 may increase or decrease the operational speeds of the conveyor belt and the pitting head assembly, respectively by using, for example a variable frequency drive (VFD). A variable frequency drive (which may also be referred to as an adjustable-frequency drive, adjustable-speed drive, variable-speed drive, AC (alternating current) drive, micro drive, inverter drive, or drive, and others) includes a type of AC motor drive (or a system incorporating a motor) that controls the speed or torque (or a combination) by varying the frequency of the input electricity in some embodiments. A VFD is known to be more efficient than, for example, hydraulic systems such as in systems with pumps and damper control for fans the associated voltage or current variation.

The variable frequency drive 904 or its equivalents may be operatively coupled with, for example, a potentiometer or a digital voltage readout 906 together with a user interface or operator interface 940 that allow an operator or the control module (e.g., 808 or 810, or both) to adjust the frequency of the VFD to achieve speed control. In some embodiments, the operational speed of the conveyor (and hence that of the conveyor belt therein) and the operational speed of the pitting head assembly may be synchronized so as to avoid, eliminate, or at least reduce undesired wait time or under-utilization of the conveyor assembly or the pitting head assembly, or both, as well as mismatched operational speeds when one of the two aforementioned assemblies operates at a speed that the other of the two aforementioned assemblies is unable to catch up with. In some of these embodiments, any adjustment to the speed control of one of the conveyor assembly and the pitting head assembly leads to an automatic adjustment of the other of the conveyor assembly and the pitting head assembly. In some other embodiments, the operational speeds of the conveyor assembly and the pitting head assembly may be independently adjusted, although synchronization between the operational speeds of the conveyor assembly and the pitting head assembly may still be desirable as delineated above.

The apparatus for pitting fruits may also include one or more of pneumatic, electrical, or mechanical components, or a combination, or sub-assemblies that may be subject to control by the pneumatic, electrical, or mechanical control 916, or a combination, in some embodiments. In these embodiments, the apparatus for pitting fruits may include one or more detectors, one or more gauges, or one or more sensors, or a combination, and others. The output of these one or more detectors, one or more gauges, or one or more sensors, or a combination, or others may be provided to the pneumatic, electrical, or mechanical control 916, or a combination, that may issue signals or instructions to control, for example, one or more valves, flow meters, switches, and the like 918 or flow control 920, or a combination.

The apparatus for pitting fruits may include one or more safety interlocks 922 that may be triggered by, for example, the output or state of one or more switches 924, one or more optical sensors 926, one or more detectors 928, one or more locks 930, one or more switches, and others to guard against electrical and mechanical issues 932 that may lead to safety concerns. For example, the pitting head assembly includes a large number of components exhibiting rotatory or linear motions, or a combination, and is thus at least partially enclosed in a guarding 106 to prevent such safety concerns from happening. The guarding 106 or a portion thereof (e.g., an access or service panel) may be equipped with an interlock switch so that a warning or a stop signal may be issued to stop the operation of the pitting head assembly or even the entire apparatus when the guarding 106 or the portion thereof is somehow removed.

The electronic control 110 may include a singulation or orientation control 804, or both, that may detect whether singulation is achieved or whether fruits are in the correct orientation, or a combination, to be pitted in some embodiments or control or adjust various aspects, or a combination, of the apparatus for pitting fruits to better achieve singulation and correct orientation of fruits. The singulation or orientation control 804, or both, may detect whether singulation or correct orientation, or both, is achieved based on the output of, for example, one or more optical sensors 908, a machine vision device 910, or any other suitable devices that may detect whether singulation or correct orientation, or both, is achieved.

For example, the calyx end of a date is supposed to face a plucker assembly. An optical sensor 908 or a machine vision device 910 may be utilized to detect whether a date is in the correct orientation. If not, the orientation control 804 may issue a signal or an instruction to an orientator 912 that may, for example, manipulate the incorrectly oriented dates into the correct orientation in some embodiments or may remove the incorrectly oriented dates from the conveyor belt so that these incorrectly oriented dates will not be processed to cause waste.

As another example, to avoid a plucker assembly or a gripper assembly from ramming into multiple fruits stacking on top of one another, an optical sensor 908 or a machine vision device 910 may be utilized to detect whether multiple dates are stacked. If not, the singulation control 804 may issue a signal or an instruction to a singulator 914 that may scrape the singulated dates in order to return the stacked dates back to the loading hopper.

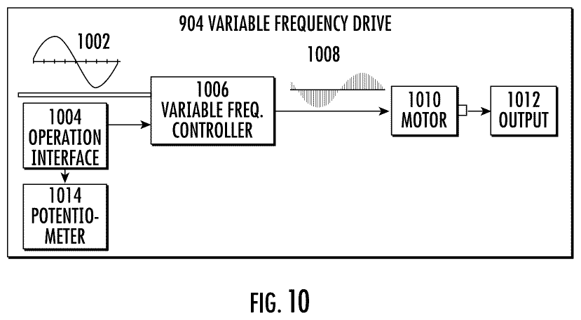

FIG. 10 shows more details about a portion of FIG. 9, according to some embodiments. More specifically, FIG. 10 shows a simplified schematic of a variable frequency drive. In these embodiments, an example variable frequency drive (VFD) may include a variable frequency controller 1006 that receives AC (alternating current) power 1002 (e.g., sine wave AC power input) and may be operatively coupled with or include an operation interface 1004 and a potentiometer 1014 for a user (e.g., an operator) to set the desired output 1008. In some embodiments, the variable frequency controller 1006 performs power conversion from the input power 1002 (e.g., sine wave AC power) into the variable frequency power 1008. The variable frequency power 1008 is provided to drive an AC motor 1010 (e.g., a single-phase motor, a synchronous motor, a three-phase induction motor, a gear motor, and others) that converts the electrical energy from the input variable frequency power 1008 into the output 1012 of mechanical energy.

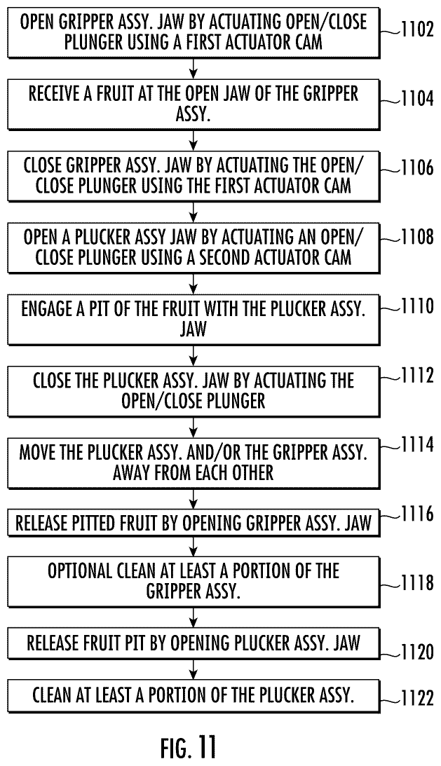

FIG. 11 shows a block diagram for pitting fruits, according to some embodiments. In these embodiments, the jaw of a gripper assembly of an apparatus for pitting fruits may be opened at 1102. In some of these embodiments, the gripper assembly jaw may be opened and closed by actuating an open-close plunger, which may be part of the gripper assembly is operatively coupled to the jaw having a plurality of fingers, with a first actuator cam. In some embodiments, an apparatus for pitting fruits may comprise a plurality of gripper assemblies that may be slidably mounted in a pitting head assembly to travel along one direction by using the first actuator cam which comprises a profile surface that may be in direct contact with the open-close plunger of a gripper assembly. The profile surface may be devised in such a way that it not only actuates the open-close plunger of a gripper assembly upon a direct contact between the profile surface and the open-close plunger but also drives the entire gripper assembly to move forward and backward through cam actions.

These fingers of the gripper assembly jaw (as well as other components having surfaces in direct contact with the fruits such as the fingers of a plucker assembly) may be constructed using food grade materials such as food grade plastics, food grade stainless steel, and others. A fruit may be received at the open jaw of the gripper assembly at 1104 where the fingers of the gripper assembly may be opened by using at least the aforementioned first actuator cam.

The gripper assembly jaw may then be closed to secure the fruit with the gripper assembly jaw at 1106. In some embodiments, the gripper assembly jaw may also be closed by using the first actuator cam. For example, the gripper assembly jaw may be spring loaded with a return spring where a direct contact between the first actuator cam and the open-close plunger of the gripper assembly compresses the return spring, and disengaging the first actuator cam from the open-close plunger (e.g., by rotating the first actuator cam to increase the distance between the profile surface and the open-close plunger to separate the open-close plunger from the profile surface of the first actuator cam) may cause the compressed return spring to return to its neutral or closed state and thus releases the fingers of the gripper assembly.

The jaw of a plucker assembly may be opened at 1108 so that the fingers of the jaw of the plucker assembly may engage with an end portion (e.g., a smaller portion of the calyx end of a fruit that is sufficient for the fingers to engage with the pit of the fruit). In some embodiments, a plucker assembly jaw may be opened and closed using at least an open-close plunger and a second actuator cam. The plucker assembly jaw may be engaged with the pit of the fruit at 1110. For example, the plucker assembly (comprising the jaw) may be advanced to a position relative to the fruit the is being secured by the gripper assembly jaw at 1106 so that the plucker assembly jaw, when closed, exerts sufficient grabbing power on the pit of the fruit (e.g., sufficient grabbing power to pull the pit out of the fruit when the fruit is held by the gripper assembly jaw). The plucker assembly may be advanced just enough for the plucker assembly jaw to exert such a sufficient grabbing power because once the fingers of the plucker assembly jaw close to grab the pit, these fingers may cut through the epicarp and mesocarp of the fruit. When the plucker assembly pulls away while grabbing onto the pit, a minor amount of the epicarp and mesocarp may also be removed together with the pit and thus reduces the yield. In some embodiments, the travel of a plucker assembly relative to a fruit may be optimized or devised in such a way to minimize or at least reduce waste or to improve or maximize yield.

At 1112, the plucker assembly jaw may be closed by, for example, actuating the open-close plunger of the plucker assembly using the second actuator cam in some embodiments. The plucker assembly or the gripper assembly, or both, may be moved away from each other at 1114 so that the pit, which is being grabbed by the plucker assembly jaw, may be removed from the fruit. In some embodiments, only one of the plucker assembly and the gripper assembly is moved at 1114 while in some other embodiments, both the plucker assembly (e.g., by actuating the first actuator cam) or the gripper assembly (e.g., by actuating the second actuator cam), or both, are moved to remove the pit from the fruit.

When the pit is being removed from the fruit, the plucker assembly holds the pit while the gripper assembly holds the pitted fruit. At 1116, the pitted fruit may be released by opening the gripper assembly jaw. Optionally, the gripper assembly or at least a portion thereof (e.g., the gripper assembly jaw or the fingers thereof) may be cleaned at 1118 in some embodiments. In some of these embodiments, the gripper assembly or at least the portion thereof may be cleaned using, for example but not limited to, compressed air flow, water stream, or any other suitable cleansing media (collectively cleansing fluid) by directing the cleansing fluid using, for example, a nozzle.

In some embodiments, a gripper assembly or at least a portion thereof may be cleaned at 1118 for every fruit that is processed by the gripper assembly while in some other embodiments, a gripper assembly or at least a portion thereof may be cleaned at 1118 after the gripper assembly has processed a number of fruits, and the number may be optimized or at least improved at least by balancing the yield of the fruit pitting apparatus, the case or difficulty of cleaning (e.g., longer time period between cleaning may lead to more resilient buildup released from the fruits during pit removal), the amount of time needed per cleaning cycle (e.g., longer time period between cleaning may need a longer cleaning time period), or any other factors or criteria pertaining to producing pitted fruits.

At 1120, the fruit pit may be released by opening the plucker assembly jaw.

Optionally, the plucker assembly or at least a portion thereof (e.g., the plucker assembly jaw or the fingers thereof) may be cleaned in some embodiments. In some of these embodiments, the plucker assembly or at least the portion thereof may be cleaned at 1222 using, for example but not limited to, compressed air flow, water stream, or any other suitable cleansing media (collectively cleansing fluid) by directing the cleansing fluid using, for example, a nozzle.

In some embodiments, a plucker assembly or at least a portion thereof may be cleaned at 1122 for every fruit that is processed by the plucker assembly while in some other embodiments, a plucker assembly or at least a portion thereof may be cleaned at 1122 after the plucker assembly has processed a number of fruits, and the number may be optimized or at least improved at least by balancing the yield of the fruit pitting apparatus, the case or difficulty of cleaning (e.g., longer time period between cleaning may lead to more resilient buildup released from the fruits during pit removal), the amount of time needed per cleaning cycle (e.g., longer time period between cleaning may need a longer cleaning time period), or any other factors or criteria pertaining to producing pitted fruits. In some embodiments, a plucker assembly and its corresponding gripper assembly may be cleaned at the same frequency or even at the same time while in some other embodiments, a plucker assembly and its corresponding gripper assembly may be cleaned at different frequencies or even at different time points.

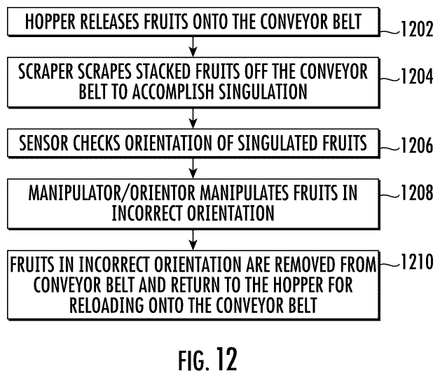

FIG. 12 shows an example block diagram for singulation, according to some embodiments. In these embodiments, fruits may be released at 1202 from a loading hopper to a conveyor belt of a conveyor assembly. A mechanically- or pneumatically-driven scraper (e.g., a brush having soft bristles or any other materials or configurations that will not damage the pericarp of fruits) may be actuated to scrap stacked fruits off the conveyor belt at 1204 to accomplish singulation. For example, a scraper may be positioned at a position to sweep across the conveyor belt where the lowest point or the lower portion of the scraper, when scraping, will exert sufficient force to scrape fruits that are stacked on top of the first layer of fruits off the conveyor belt but will not exert sufficient force to scrape the first layer fruits directly contacting the conveyor belt off the conveyor belt.

In some embodiments, the scraper may be actuated periodically or continuously (reciprocating back and forth) while in some other embodiments, the scraper may be actuated when it is detected that some fruits are stacked and thus fail to achieve singulation. Fruits having pits to be removed are oriented with their calyx ends facing the plucker assembly because, as shown in FIG. 3, the pit of a fruit is usually attached to or in close proximity of the calyx. As a result, when a plucker assembly opens its jaw to approach the fruit, the plucker assembly jaw may successfully grab the end portion of the pit if the fruit is in the correct orientation. In some embodiments, the orientation of a fruit on the conveyor belt with its pit to be removed may be checked at 1206 to determine whether the fruit is in the correct orientation. In some embodiments, the aforementioned orientation checks may be performed by using one or more sensors while in some other embodiments, fruit orientation may be checked manually.

When it is determined that a fruit is in an incorrect orientation (e.g., the calyx end that is supposed to face a plucker assembly actually faces a gripper assembly), a manipulator or orientor may be actuated to manipulate the fruit that is in an incorrect orientation at 1208. In some of these embodiments, the orientation of the fruit in the incorrect orientation may be corrected by the manipulator or orientor while in some other embodiments, the orientation of the fruit in the incorrect orientation may be corrected manually. In some embodiments, a fruit in an incorrect orientation may be removed at 1210 from the conveyor belt and returned to the feed end of the conveyor belt or to the loading hopper.

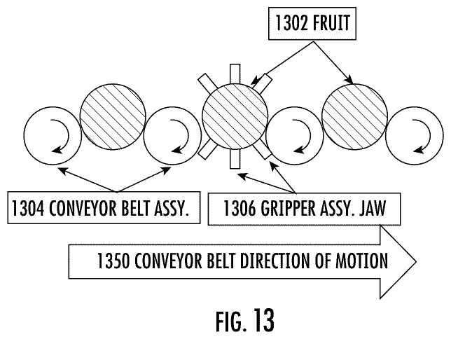

FIG. 13 shows a simplified example portion of a conveyor belt carrying singulated fruits for pitting the fruits, according to some embodiments. In these embodiments, FIG. 13 shows a portion of a conveyor belt that comprises a plurality of rollers 1304 that are respectively spaced from one another at a spacing value. The spacing value may be determined based at least in part upon one or more factors comprising, for example but not limited to, the range of the variable sizes of the fruits 1302 to be processed, the gripper assembly design, the gripper assembly jaw design, the plucker assembly design, the plucker assembly jaw design, or any other suitable factors, or any combinations thereof.

The plurality of rollers 1304 may be linked together to form a conveyor belt that may be driven together with the plurality of rollers by, for example, a variable frequency drive or a motor, in some embodiments. When singulation is achieved, each spacing between two immediately neighboring rollers may carry at most one fruit 1302 with no other fruits stacking on top. The spacing between two immediately neighboring rollers 1304 may be devised to clear at least the gripper assembly jaw or the plucker assembly jaw, or both, in some embodiments so that the gripper assembly jaw may reach in with the movement of the gripper assembly to secure the fruit 1302 for pit removal, and the plucker assembly jaw may grab onto the calyx end portion of the fruit 1302 for pit removal. In some embodiments, the conveyor belt may pause when a gripper assembly and a plucker assembly are actuated to remove the pit from a fruit 1302. In some other embodiments, the conveyor belt may continue to move in a radial or linear direction 1350 together with the plurality of gripper assemblies and the plurality of plucker assemblies in a synchronized manner so that the conveyor belt does not stop at all for pit removal.

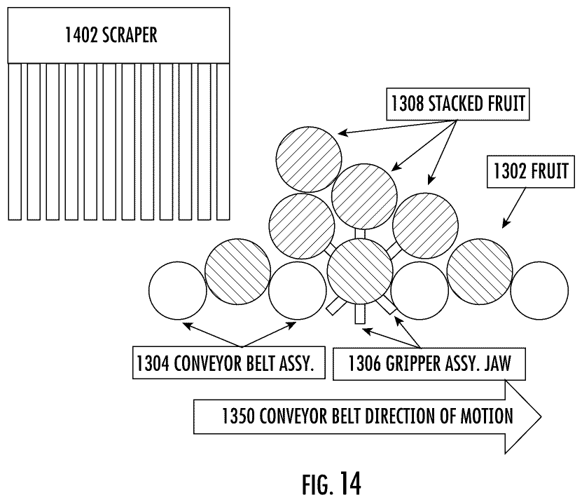

FIG. 14 shows an example of feeding a conveyor belt with a loading hopper and an example method for achieving singulation, according to some embodiments. In this example shown in FIG. 14, the conveyor belt 1304 carries the first level of fruits 1302, yet more than one layer of fruits 1308 are stacked on top of the conveyor belt 1304. In some embodiments, a scraper 1402 may be actuated to scrape the stacked fruits 1308 off the first layer of fruits 1302 to achieve singulation.

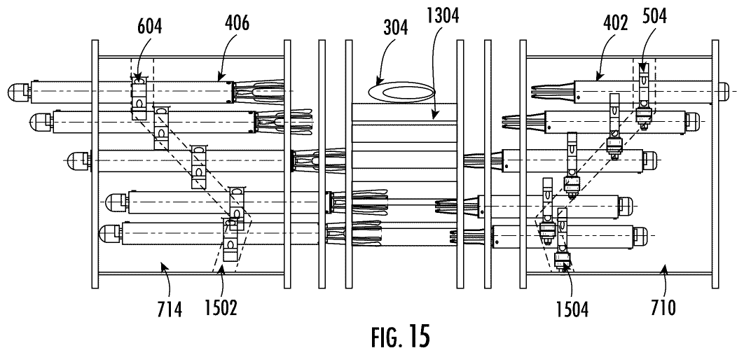

FIG. 15 shows a simplified schematic diagram of a side view of a portion of an example pitting head assembly of an apparatus for pitting fruits, according to some embodiments. More specifically, FIG. 15 shows a simplified example of synchronizing the actuation of a plurality of gripper assemblies and the actuation of a plurality of plucker assemblies for pit removal. In these embodiments, a plurality of gripper assemblies 406 may be arranged in a circular pattern and may be driven by a gripper actuator assembly (e.g., 714 in FIG. 7A) that houses a gripper actuator cam (e.g., 706 in FIG. 7A) comprising a gripper actuator cam profile surface (e.g., 706A in FIG. 7A). Similarly, a plurality of plucker assemblies 402 may be arranged in a circular pattern and may be driven by a plucker actuator assembly (e.g., 710 in FIG. 7A) that houses a plucker actuator cam (e.g., 716 in FIG. 7A) comprising a plucker actuator cam profile surface (e.g., 716A in FIG. 7A).

Each of the plurality of gripper assemblies 406 may include a gripper cam block 604; and each of the plurality of plucker assemblies 402 may include a plucker cam block 504. In addition to driving the plurality of gripper assemblies 406 using the gripper cam block 604, the gripper actuator cam 706 may also include a cutout 1502 that is used to guide or restrain the movement of the gripper cam blocks 604 of the plurality of gripper assemblies 406. Similarly, in addition to driving the plurality of plucker assemblies 402 using the plucker cam block 504, the plucker actuator cam 716 may also include a cutout 1504 that is used to guide or restrain the movement of the plucker cam blocks 504 of the plurality of plucker assemblies 402.

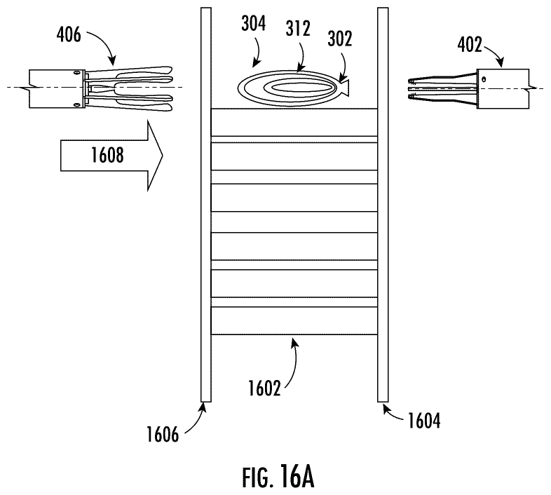

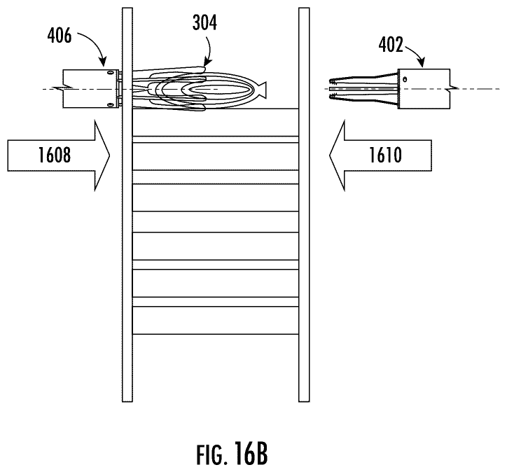

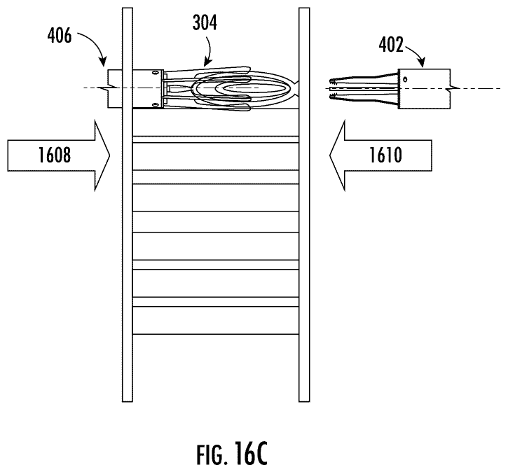

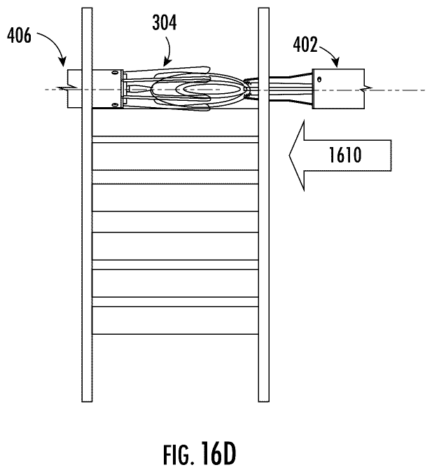

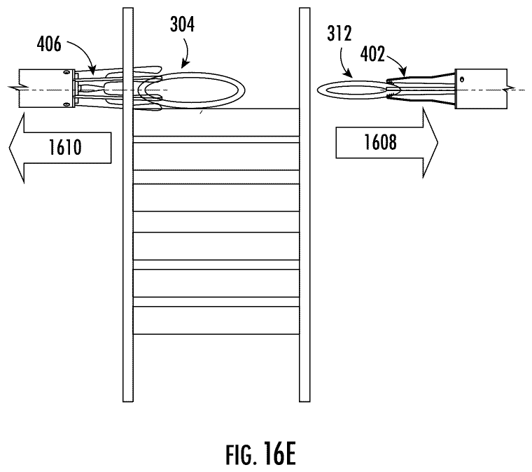

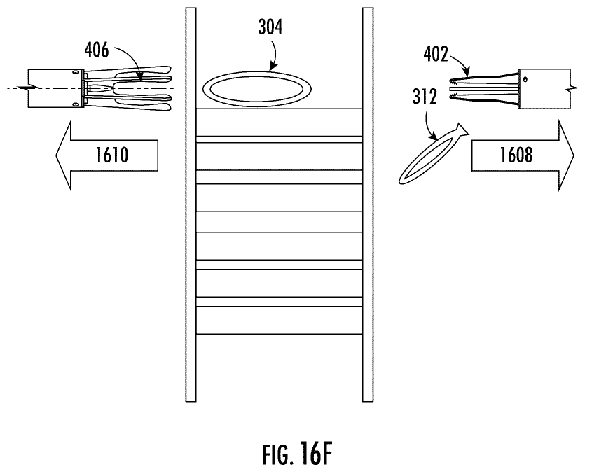

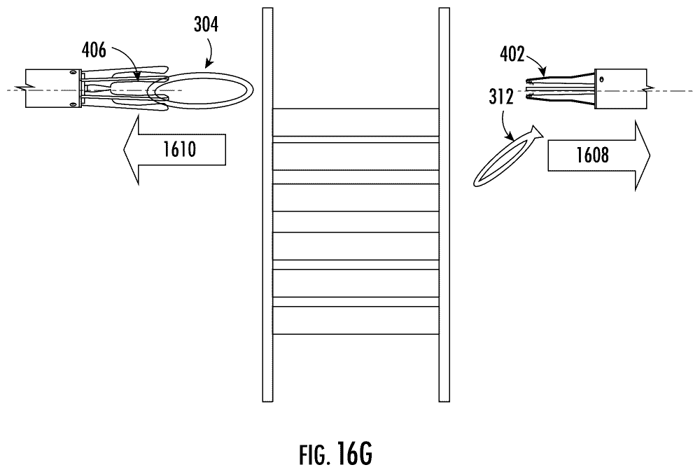

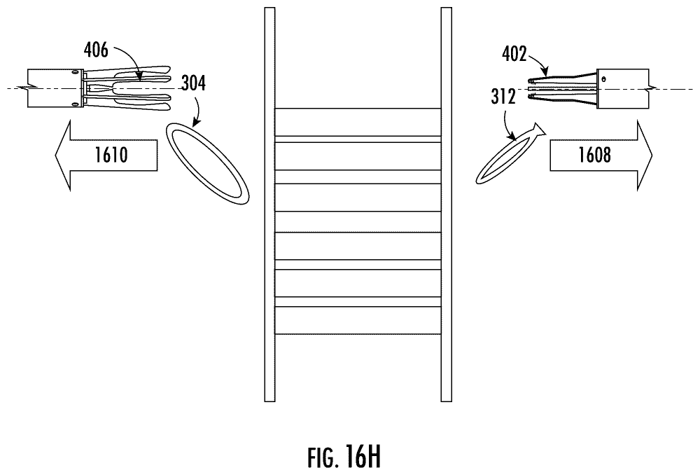

The gripper actuator cam profile surface (e.g., 706A in FIG. 7A) and the plucker actuator cam profile surface (e.g., 716A in FIG. 7A) may be devised and configured in such a way to synchronize the actuation and movement as well as the timing thereof for the plurality of gripper assemblies 406 and the plurality of plucker assemblies 402. More details about the actuation and movement as well as the timing thereof for the plurality of gripper assemblies 406 and the plurality of plucker assemblies 402 are described below with reference to FIGS. 16A-16H.

The plurality of gripper assemblies 406, as shown in FIG. 15, is positioned on one side of the conveyor belt 1304 while the plurality of the plucker assemblies 402 is positioned on the other side of the conveyor belt 1304 carrying fruit 406 to be pitted where a gripper assembly 406 advances to grab the fruit 304 with its gripper assembly jaw, and a corresponding plucker assembly 402, which is substantially aligned with the gripper assembly 406 (e.g., the gripper assembly 406 and the corresponding plucker assembly 402 would have been perfectly aligned but for a slack between mating components as designed, one or more tolerances such as a manufacturing tolerance, or normal wear and tear, or a combination, that causes deviation from perfect alignment), advances to grab onto the pit of the fruit 304 and remove the grabbed pit when the gripper assembly 406 and the plucker assembly 402 move away from each other. In addition to the synchronization between the actuation and movement as well as the timing thereof for the plurality of gripper assemblies 406 and the plurality of plucker assemblies 402, the operational speed (e.g., rotational speed as driven by a variable frequency drive) of the conveyor belt 1304 may also be synchronized with that of the gripper actuator assembly (e.g., 714 in FIG. 7A) and the plucker actuator assembly (e.g., 710 in FIG. 7A) so that each slot on the conveyor belt corresponds to a pair of a gripper assembly 406 and a plucker assembly 402 that jointly remove the pit of the fruit located in the slot.

FIGS. 16A-16H show some simplified example pitting operations of a gripper assembly and a plucker assembly for fruits carried by a conveyor belt, according to some embodiments. More specifically, FIG. 16 shows that a conveyor belt 1602 carrying a fruit having the mesocarp 304, the pit 312, and the calyx 302 in a slot on the conveyor belt 1602. Moreover, FIG. 16A shows that the fruit is approaching the position at which its pit 312 will be removed where the gripper assembly 406 advances along the direction 1608 towards the fruit.

In some embodiments, the gripper assembly 406 is actuated earlier than the plucker assembly 402 while in some other embodiments, the gripper assembly 406 and the plucker assembly 402 are actuated substantially simultaneously (e.g., by configuring the gripper actuator assembly and the plucker actuator assembly so that their respective rotations would have ideally triggered the advancements of the gripper assembly and the plucker assembly but for one or more tolerances such as a manufacturing tolerance, a slack between mating components, or normal wear and tear, or a combination, that may cause one of the two assemblies to be actuated before the other).

FIG. 16B shows the example where the gripper assembly 406 advances along the direction 1608 through the wall 1606 grabs the fruit. FIG. 16B further shows that the corresponding plucker assembly 402 is actuated to advance along the direction 1601 toward the fruit to be pitted. FIG. 16C shows the same example as FIG. 16B but at a moment later. More specifically, the gripper assembly 406 continues to advance along the direction 1608 until the gripper assembly 406 reaches a stop. In some embodiments, the stop may be devised to be a location where fruits of a larger size (e.g., 95th percentile of all sizes) will no smash into the wall 1604.

FIG. 16D shows the same example as FIG. 16C but at a moment later. More specifically, FIG. 16D shows that the plucker assembly 402 continues to advance toward the fruit along the direction 1610, reaches the fruit, closes the plucker assembly jaw to grab onto an end portion of the pit of the fruit with the fingers of the plucker assembly jaw. It shall be noted that although FIGS. 16C-16D show the example where the gripper assembly 406 appears to reach the stop before the plucker assembly 402 grabs the end portion of the pit of the fruit with the fingers of the plucker assembly jaw, the gripper assembly 406 and the plucker assembly 402 may be devised or configured in such a way that the plucker assembly jaw grabs onto the end portion of the fruit at substantially the same time (e.g., slight deviation in time due to one or more tolerances such as a manufacturing tolerance, a slack between mating components as designed, or normal wear and tear in various components such as the actuator cam) when the gripper assembly 406 reaches the aforementioned stop.

FIG. 16E shows the example where the gripper assembly 406 and the plucker assembly 402 move away from each other while the gripper assembly 406 holds onto the fruit, and the plucker assembly 402 grabs the end portion of the pit of the fruit so that the pit is removed from the fruit. For example, the gripper assembly 406 may retract along the direction 1610 (e.g., due to the rotation of the actuator cam 716) while holding onto the fruit, and the plucker assembly 402 may retract (e.g., due to the rotation of the actuator cam 706) along the direction 1608 while grabbing the end portion of the pit of the fruit. The plucker assembly jaw may be devised to exert sufficient force to grab the end portion of the pit so that the pit is pulled out of the fruit due to the relative movement between the gripper assembly 406 and the plucker assembly 402.

FIG. 16F shows the example where the gripper assembly 406 may open its gripper assembly jaw to release the pitted fruit 304, and the plucker assembly 402 may open its plucker assembly jaw to release the pit 312. Release of the pitted fruit may occur at any time after the pit is removed from the fruit. Similarly, release of the pit may also occur at any time after the pit is removed from the fruit. The example shown in FIG. 16F shows that the gripper assembly releases the pitted fruit so that the pitted fruit stays on the conveyor belt (and may be collected via, for example, the discharge channel 118), while the plucker assembly 402 releases the pit 312 after the pit is entirely outside the conveyor belt area so as to avoid commingling pits and pitted fruits.

In comparison, FIG. 16G shows another example where the gripper assembly 406 grabs the pitted fruit 304 until the pitted fruit is completely outside the conveyor belt area. FIG. 16G similarly shows that the plucker assembly 402 releases the pit 312 after the pit is entirely outside the conveyor belt area so as to avoid commingling pits and pitted fruits. FIG. 16H shows the example where the gripper assembly 406 pulls the pitted fruit 304 completely outside the conveyor belt area before releasing the pitted fruit 304. In some embodiments, a gripper assembly 406 may release the pitted fruit 304 while the gripper assembly 406 is retracing. In some other embodiments, a gripper assembly 406 may hold onto the pitted fruit 304 and releases the pitted fruit when the gripper assembly 406 comes to another stop at which the motion of the gripper assembly changes from retraction to advancement due to the rotation of the gripper assembly actuator cam.

Table A below shows some example test results of some techniques for pitting fruits described herein, according to some embodiments. More specifically, Table A shows the working examples of successful tests of various techniques described herein at multiple different ambient temperatures where various techniques described herein successfully with over 90 percent of yield and thus reduce waste. Moreover, these tests demonstrate the efficiency and effectiveness of various techniques by providing a throughput of 175-176 pounds of dates per hour. In comparison, a skilled worker or farmer can at best manually remove less than 10 pounds of dates per hour. Some legacy approaches require preheating the fruits before pitting because some theories believe that fruits at warmer temperatures pit better. Nonetheless, as demonstrated in table A below, various techniques described herein have proven that these techniques described here can operate at ambient temperature with at least comparable, if not better, pitting results (e.g., yield, throughput, and so forth) and thus eliminate the need for preheating the fruits. Table A below further shows that various techniques described herein not only set aside the requirements of preheating fruits for pit removal but also demonstrates that the higher yield of pit removal at ambient temperature. As it can be seen from the test results in table A below, test #1 at elevated temperatures with preheating the fruits before pit removal loses 0.78 (21.88 minus 20.0 minus 1.10) pounds of fruits while test #2 loses 0.09 lbs. of fruits (21.59 minus 20.7 minus 0.8). These test results evidence the higher efficiencies and effectiveness of various techniques described herein for pit removal.

TABLE A
Test Results

| | | Starting | Pitted | Pits | | | Run |
|---|---|---|---|---|---|---|---|
| | Temperature | Weight | Weight | Weight | Yield | Throughput | Time |
| Trial # | (degrees F.) | (lbs) | (lbs) | (lbs) | (%) | (lbs/hour) | (hours) |
| 1 | 85-95 | 21.88 | 20.0 | 1.10 | 91.4 | 175 | 0.125 |
| 2 | 71 | 21.59 | 20.7 | 0.80 | 95.7 | 176 | 0.1225 |

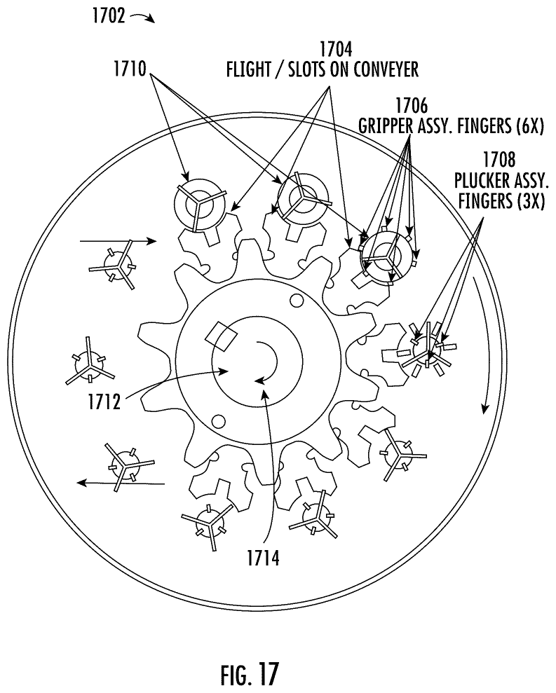

FIG. 17 shows a simplified example of a conveyor belt having a plurality of flights or slots carrying some fruits on the conveyor belt for pit removal, according to some embodiments. In these embodiments, the conveyor belt in the example 1702 may be operatively coupled to a driving mechanism (e.g., a drive shaft 1712) to rotate in the direction 1714 as shown in FIG. 17. The conveyor belt may include a plurality of flights or slots 1704 for carrying fruits 1710 for pit removal. FIG. 17 further shows an example way for the gripper assembly fingers 1706 (a total of six in this example) and the plucker assembly fingers 1708 (a total of three in this example) to clear the conveyor belt while the fruit is accommodated in a slot of the conveyor belt. Moreover, the pitting head assembly in this example shown in FIG. 17 includes ten (10) pairs of gripper assemblies and plucker assemblies.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

What is claimed is:

1. A system comprising:
a conveyor belt that comprises a slot or a recessed area, wherein the slot or the recessed area accommodates a fruit to be pitted;
a pitting head assembly that comprises a gripper assembly and a plucker assembly and is coupled with the conveyor belt to receive the fruit into the pitting head assembly;
a guarding that encloses at least a portion of the pitting head assembly; and
a device that converts an electrical energy input into a mechanical energy output and is coupled with the pitting head assembly to drive the gripper assembly and the plucker assembly.

2. The system of claim 1 wherein the pitting head assembly comprises:
a gripper actuator cam that is coupled with the device to receive the mechanical energy output, wherein the mechanical energy output causes the gripper actuator cam to rotate around a gripper actuator cam axis; and
a plucker actuator cam that is coupled with the device to receive the mechanical energy output, wherein the mechanical energy output causes the plucker actuator cam to rotate around a plucker actuator cam axis.

3. The system of claim 2 wherein
the plucker actuator cam comprises a plucker actuator cam profile surface that is in contact with a first end portion of the plucker assembly, wherein the plucker assembly comprises a plucker assembly jaw that comprises a plurality of plucker fingers; and
the gripper actuator cam comprises a gripper actuator cam profile surface that is in contact with a first end portion of the gripper assembly, wherein the gripper assembly comprises a gripper assembly jaw that comprises three or more gripper fingers.

4. The system of claim 3 wherein
the plucker assembly comprises the plucker assembly jaw at a first end of the plucker assembly and a plucker jaw plunger at a second end of the plucker assembly,
the plucker jaw comprises the plurality of plucker fingers at the first end of the plucker assembly, and
a plucker finger of the plurality of plucker fingers comprises at least one tooth.

5. The system of claim 4 wherein the plucker assembly further comprises:
a plucker jaw actuator that is coupled with the plucker jaw plunger and the plurality of plucker fingers of the plucker assembly jaw, wherein
the plucker jaw actuator comprises a same number of curved geometric features that respectively correspond to the plurality of plucker fingers,
actuation of the plucker jaw plunger using the plucker actuator cam opens the plurality of plucker fingers, and
release of the plucker jaw plunger using the plucker actuator cam closes the plurality of plucker fingers.

6. The system of claim 3 wherein
the gripper assembly comprises the gripper assembly jaw at a first end of the gripper assembly and a gripper jaw plunger at a second end of the gripper assembly,
the gripper assembly jaw comprises the three or more gripper fingers at the first end of the gripper assembly, and
a gripper finger of the three or more of gripper fingers comprises a gripper finger profile that includes multiple different widths without sharp corners when transitioning among the multiple different widths.

7. The system of claim 6 wherein the gripper assembly further comprises:
a gripper jaw actuator that is coupled with the gripper jaw plunger and the three or more gripper fingers of the gripper assembly jaw, wherein
the gripper jaw actuator comprises a same number of curved geometric features that respectively correspond to the three or more gripper fingers,
actuation of the gripper jaw plunger using the gripper actuator cam opens the three or more gripper fingers, and
release of the gripper jaw plunger using the gripper actuator cam closes the three or more gripper fingers.

8. The system of claim 1 wherein
the gripper assembly comprises a gripper assembly jaw at a first end of the gripper assembly and a gripper jaw plunger at a second end of the gripper assembly,
the gripper assembly jaw comprises three or more gripper fingers at the first end of the gripper assembly, and
a gripper finger of the three or more gripper fingers comprises a plurality of widths without sharp corners when transitioning among the plurality of widths.

9. The system of claim 1 wherein the gripper assembly is substantially aligned with the plucker assembly along an axial direction along which both the gripper assembly and the plucker assembly move back and forth.

10. The system of claim 1 further comprising:
an electronic control subsystem that is coupled with the pitting head assembly and the conveyor belt and further comprises:
a first speed control circuit that is coupled with and controls an operational speed of the conveyor belt or an operational speed of the pitting head assembly using a first variable frequency drive based at least in part upon an input at an operator interface.

11. The system of claim 10 wherein the electronic control subsystem further comprises:
a pneumatic control device that controls first operations of a pneumatic device in the system based at least in part upon a first output of a first detector, a first gauge, or a first sensor;
an electrical control device that controls second operations of an electrical device in the system based at least in part upon a second output of a second detector, a second gauge, or a second sensor; and
one or more safety interlocks that disable at least a portion of the system based at least in part upon an output or a state of a safety switch, an optical safety device, a safety detector, or a safety lock.

12. The system of claim 10 wherein the electronic control subsystem further comprises:
a singulation control device that controls a singulator based at least in part upon an output of a first optical sensor or a first machine vision device, wherein the singulator operates to eliminate or reduce a stacked fruit that is stacked on top of or above the fruit that is in direct contact with the conveyor belt.

13. The system of claim 10 wherein the electronic control subsystem further comprises:
a second speed control circuit that is coupled with and controls an operational speed of the pitting head using a second variable frequency drive, wherein the second speed control circuit is coupled with and controls the operational speed of the conveyor belt; and
an orientation control device that controls an orientor based at least in part upon an output of a second optical sensor or a second machine vision device, wherein the orientor operates to orient the fruit so that a calyx end of the fruit faces a plucker assembly jaw of the plucker assembly.

14. The system of claim 1 further comprising:
a loading hopper that is coupled with the conveyor belt, wherein the fruit is automatically transported from the loading hopper to the pitting head assembly via at least the conveyor belt; and
a level, volume, or quantity sensor that monitors a level, volume, or quantity of fruits in the loading hopper, wherein the loading hopper is further coupled with an upstream conveyor that replenishes contents of the loading hopper based at least in part upon an output of the level, volume, or quantity sensor.

15. The system of claim 1 further comprising:
a plurality of plucker assemblies that is arranged in a pattern, the plurality of plucker assemblies comprising the plucker assembly;
a plucker actuator cam that drives at least one of plucker assembly of the plurality of plucker assemblies between a first timepoint when the at least one plucker assembly makes a direct contact with the plucker actuator cam and a second timepoint when the plucker assembly releases the direct contact with the plucker actuator cam;
a plurality of gripper assemblies including the gripper assembly, wherein the plurality of gripper assemblies is arranged in the pattern in which the plurality of plucker assemblies is also arranged;
a gripper actuator cam that drives at least one gripper assembly of the plurality of gripper assemblies between a third timepoint when the at least one gripper assembly makes a direct contact with the gripper actuator cam and a fourth timepoint when the at least one gripper assembly releases the direct with the gripper actuator cam, wherein
movements of the plurality of gripper assemblies controlled by the gripper actuator cam is synchronized with movements of the plurality of plucker assemblies controlled by the plucker actuator cam.

16. A method comprising:
receiving a fruit on a conveyor belt in a pitting head assembly;
actuating a gripper assembly including a gripper assembly jaw to grab a fruit end portion of an end of the fruit using the gripper assembly jaw having three or more gripper fingers, wherein the end of the fruit is opposite to a calyx end near the calyx of the fruit;
actuating a plucker assembly include a plucker assembly jaw to grab a pit end portion of a pit of the fruit using the plucker assembly jaw having a plurality of plucker fingers, wherein a plucker finger of the plurality of plucker fingers comprises one or more teeth that cut into an epicarp of the fruit to grab the pit end portion of the pit; and
removing the pit from the fruit at least by moving the gripper assembly or the plucker assembly away from one another.

17. The method of claim 16 further comprising at least one of:
cleaning the gripper assembly at least by dispensing a cleansing fluid onto at least a portion of the gripper assembly, after the gripper assembly releases a pitted fruit of the fruit; or
cleaning the plucker assembly at least by dispensing the cleansing fluid onto at least a portion of the plucker assembly, after the plucker assembly releases the pit from the fruit.

18. The method of claim 16 actuating the plucker assembly comprising:
moving the plucker assembly toward the fruit on the conveyor belt;
opening the plurality of plucker fingers of the plucker assembly jaw at least by actuating a plucker jaw actuator with a plucker assembly plunger;
stopping the plucker assembly at a plucker stop position; and
closing the plurality of plucker fingers of the plucker assembly jaw at least by releasing the plucker jaw actuator with the plucker assembly plunger.

19. The method of claim 16 wherein actuating the gripper assembly comprises:
moving the gripper assembly toward the fruit on the conveyor belt;
opening the three or more gripper fingers of the gripper assembly jaw at least by actuating a gripper jaw actuator using at least a gripper assembly plunger;
stopping the gripper assembly at a gripper stop position; and
closing the three or more gripper fingers of the gripper assembly jaw at least by releasing the gripper jaw actuator using at least the gripper assembly plunger.

20. The method of claim 16 further comprising:
singulating a plurality of fruits on the conveyor belt to eliminate or at least reduce a number of stacked fruits that is stacked on top of or above the fruit that is in direct contact with the conveyor belt.

21. The method of claim 15 further comprising:
orienting the fruit on the conveyor belt so that a calyx end near a calyx of the fruit is facing the plucker assembly jaw of the plucker assembly when the plucker assembly moves or is to move toward the fruit for pit removal, wherein
a first end of the fruit opposing the calyx end is facing the gripper assembly jaw of the gripper assembly when the plucker assembly or the gripper assembly moves or is to move toward the fruit for the pit removal.

22. A pitting head assembly for removing a pit from a fruit comprising:
a plucker assembly;
a plucker actuator cam that drives the plucker assembly between a first timepoint when the plucker assembly makes a first direct contact with the plucker actuator cam and a second timepoint when the plucker assembly releases the first direct with the plucker actuator cam;
a gripper assembly; and
a gripper actuator cam that drives the gripper assembly between a third timepoint when the gripper assembly makes a second direct contact with the gripper actuator cam and a fourth timepoint when the gripper assembly releases the second direct with the gripper actuator cam.

23. The assembly of claim 22 further comprising:
a plurality of plucker assemblies comprising the plucker assembly, the plurality of plucker assemblies arranged in a pattern, wherein
the plucker actuator cam that drives each plucker assembly of the plurality of plucker assemblies between the first timepoint when the each plucker assembly makes the first direct contact with the plucker actuator cam and the second timepoint when the each plucker assembly releases the first direct contact with the plucker actuator cam, and
movements of the gripper assembly is synchronized with movements of the plucker assembly.

24. The assembly of claim 23 further comprising:
a plurality of gripper assemblies comprising the gripper assembly, the plurality of gripper assemblies arranged in the pattern in which the plurality of plucker assemblies is also arranged, wherein
the gripper actuator cam drives each gripper assembly of the plurality of gripper assemblies between the third timepoint when the each gripper assembly makes the second direct contact with the gripper actuator cam and the fourth timepoint when the each gripper assembly releases the second direct contact with the gripper actuator cam, and
movements of the plurality of gripper assemblies are synchronized with movements of the plurality of plucker assemblies.
